(19) United States
(12) Patent Application Publication
(10) Pub. No.: US 2022/0180345 A1
(43) Pub. Date: Jun. 9, 2022

(54) SPLIT PAYMENT METHOD AND USE THEREOF

(71) Applicant: LYDIANS ELEKTRONIK PARA VE ODEME HIZMETLERI ANONIM SIRKETI, Istanbul (TR)

(72) Inventor: Fatih TOSMUR, ADANA (TR)

(73) Assignee: LYDIANS ELEKTRONIK PARA VE ODEME HIZMETLERI ANONIM SIRKETI, Istanbul (TR)

(21) Appl. No.: 17/341,405

(22) Filed: Jun. 8, 2021

(30) Foreign Application Priority Data
Dec. 9, 2020 (TR) 2020/20100

(51) Int. Cl. G06Q 20/22; G06Q 20/40; G06Q 20/20

(52) U.S. Cl. CPC G06Q 20/29; G06Q 20/201; G06Q 20/206; G06Q 20/401

(57) ABSTRACT

A split payment method at a transaction time requires a unique/special password for a payment transaction in the time of creating a split payment definition. A split payment can be initiated before a purchase, relevant confirmations can be received from stakeholders, and the split payment can be addressed with a password defined for a specific purchase. The split payment method also provides a real time authorization mechanism that allows to split the payment amount between the stakeholders.

### CROSS REFERENCE TO THE RELATED APPLICATIONS

This application is based upon and claims priority to Turkish Provisional Application No. TR2020/20100, filed on Dec. 9, 2020, the entire contents of which are incorporated herein by reference.

### TECHNICAL FIELD

The present invention relates to the technical field of payment transaction, and more specifically to a split payment method and use thereof. Disclosed method solves the problem of splitting payment at transaction time by defining a unique password for the payment transaction in the time of creating the split payment definition. A split payment can be initiated before the purchase, relevant confirmations can be received from the stakeholders, and split payment can be addressed with a password defined for a specific purchase. The invention also provides a real time authorization mechanism that allows to split the payment amount between the stakeholders.

### BACKGROUND

Existing split payment solutions have been traditionally implemented with two different methods, since a relation between payment transaction and split payment definition could not be established directly. One method is to split the payment after the payment transaction is completed. The other method is to collect funds to an account in advance by making split payment definitions, then performing the payment transaction by using the collected funds. Neither of these methods can directly establish the relation between payment transaction and split payment definition in the time of transaction.

The first method of splitting the payment (i.e., spiting after the payment transaction is completed) can cause the following problems: (1) split payment owner must keep all transaction amount in his/her wallet before the transaction is performed, and (2) there is no real time information about the split payment related purchase for participants.

On the other hand, the second method of splitting the payment (i.e., collecting funds to an account in advance) can cause the following problems: (1) participants need to transfer the amount of the purchase before the payment occurs, (2) the return of the transferred funds is not guaranteed, and (3) there is no real time information about the split payment related purchase for participants.

### SUMMARY

The present invention relates to the technical field of payment transaction, and more specifically to a split payment method and use thereof. Disclosed method solves the problem of splitting payment at transaction time by defining a unique/special password for the payment transaction in the time of creating the split payment definition. A split payment can be initiated before the purchase, relevant confirmations can be received from the stakeholders, and split payment can be addressed with a password defined for a specific purchase. The invention also provides a real time authorization mechanism that allows to split the payment amount between the stakeholders.

In view of the problems described above, the present invention provides a split payment method and use thereof. The present invention adopts the following technical solutions: using a unique/special password for the payment transaction in the time of creating the split payment definition; initiating a split payment before the purchase; and utilizing a real time authorization mechanism that allows to split the payment amount between the stakeholders.

In some embodiments, prior to a purchase transaction, a user device defines a split payment including a split payment definition, wherein the split payment definition includes: a unique/special password or PIN, one or more participants and an amount to be charged associated with each of the one or more participants. The user device transmits the split payment definition to a payment processing unit (PPU). In performing the purchase transaction, the PPU determines whether the split payment definition will be used, and whether the unique/special password or PIN is used, and during performing the purchase transaction using the split payment, the PPU deduces the amount to be charged associated with each of the one or more participants from an account associated with each of the one or more participants.

In some embodiments, the in performing the purchase transaction, determining, by the PPU, whether the split payment definition will be used, further includes whether the transaction is marked as split payment in a card not present transaction.

In some embodiments, the user adds at least one of a note, a category of purchase transaction, a date, a time, a merchant, a merchant category, a location, and a restriction on the one or more participant to share the amount to be charged associated with each participant, to the split payment definition and determines a password confirmation to the split payment definition. In some embodiments, the user selects one or more participants from a plurality of participants from a contact list directory, or alternatively by entering a unique identifier associated with each of the one or more participants. The unique identifier is at least one of: a phone number, an account number, and a participant's email address.

In some embodiments, the payment processing unit (i.e., a server) upon receiving the split payment option and the split payment definition, stores the split payment definition and an identity of the user, notifies each of the one or more participants about the split payment definition, and assigns to each of the one or more participants a status as “waiting”. The payment processing unit further upon receiving a deny notification from a participant, removes the participant from the split payment definition and updates the status of the participant to denying participant and notifies the user about the deny notification and identity of the denying participant. In some embodiments, the payment processing unit upon receiving an approve notification from a participant, updates the status of the participant to approving participant, and updates the split payment definition based on the status of each of the one or more participants. Each of the one or more participants are notified sent via at least one of: a text message, a push notification, an email, and a web portal.

In some embodiments, the payment processing unit determines whether a given password for the purchase transaction matches a unique/special password or PIN assigned to the split payment definition. The PPU checks available balance of each participant for accepted amounts, and calculates the total checked amounts from approved participant (i.e., a first amount), and calculates a user's available balance in the user's account. (i.e., a second amount.) Further, if the payment processing unit determines that a sum of the first amount and the second amount is equal to or greater than a purchase transaction amount, then the payment processing unit transfers the approved amounts to the user's account from the approved participant's checked accounts and confirms the purchase transaction. The calculation and approval process have additional calculation and controls, according to definition parameters.

In some embodiments, payment processing unit receives a split payment definition request from a user device. The split payment definition request includes one or more participants, an amount to be charged associated with each of the one or more participants, an amount of a purchase transaction, and a unique/special password or PIN assigned to the split payment. The payment processing unit determines whether the amount of the purchase transaction is equal to or greater than a sum of the amounts to be charged associated with the one or more participants and the unique/special password or PIN for the split payment is different from a card PIN. If so, then the payment processing unit generates a split payment definition based at least in part on the split payment, and stores the split payment definition, the unique/special password or PIN, and the one or more participants. The payment processing unit then notifies the user device and each of the one or more participants about the generation of the split payment definition.

In some embodiments, the payment processing unit receives a request to update the split payment definition by replacing the amount of the purchase transaction with a second amount. In response, the payment processing unit updates the split payment definition by replacing the amount of the purchase transaction with the second amount.

In some embodiments, the payment processing unit receives a request to update the split payment definition by replacing the unique/special password or PIN with a second password or PIN. In response, the payment processing unit updates the split payment definition by replacing the unique/special password or PIN with the second password or PIN.

In some embodiments, the payment processing unit receives a request to add one or more additional parameters to the purchase transaction. The one or more additional parameters may include at least one of: a note, a category of purchase transaction, a date, a time, a merchant, a merchant category, a location, an expiration date for the split payment definition, and a restriction to share the amount of the one or more participants is charged, from the user device. The payment processing unit updates the split payment definition based on the first tag.

In some embodiments, upon a determination that a given password for the purchase transaction matches a unique PIN or password assigned to the split payment definition, the PPU checks available balance of each participant for accepted amounts; calculates a first amount based on a total checked amounts from the approving participants; calculates a second amount based on a user's available balance in the user's account; and transfers the accepted amounts to the user's account from the approving participants' accounts. The PPU further, upon a determination that a sum of the first amount and the second amount is equal or greater that a purchase transaction amount, transfers the accepted amounts to the user's account from the approving participants' accounts, and performs the purchase transaction.

In some embodiments, the payment processing unit receives a request to update the split payment definition by replacing the one or more additional parameters with other parameters. In response, the payment processing unit updates the split payment definition by replacing the one or more additional parameters with other parameters.

In some embodiments, the payment processing unit receives a request to update the split payment definition by deleting a participant from the one or more participants. In response, the payment processing unit updates the split payment definition by deleting a participant from the one or more participants.

In some embodiments, the payment processing unit receives a request to update the split payment definition by deleting a split payment definition. In response, the payment processing unit updates the split payment definition by deleting the split payment definition.

In some embodiments, the payment processing unit receives a request to update the split payment definition by changing an amount to be charged associated with a participant of the one or more participants. In response, the payment processing unit updates the split payment definition by changing the amount to be charged associated with one of the one or more participants.

In some embodiments, the payment processing unit receives a response from a participant of the one or more of the participants, the response being indicative of whether the participant accepted or rejected the amount to be charged associated with the participant. The payment processing unit upon a determination that the response is an acceptance, determines whether the participant is allowed to approve. Afterwards, upon a further determination that the split payment definition is active, the payment processing unit updates a status of the participant to approve.

In some embodiments, the payment processing unit receives a purchase transaction, performs a verification check specific to a financial instrument associated with the purchase transaction, determines whether the financial instrument is authorized to participate in the purchase transaction, and upon a determination that the unique/special password or PIN is defined for the split payment definition, determines whether the split payment definition is active. The payment processing unit upon a determination that the split payment definition is active, determines whether there are any restrictions or rules that prevent performing the purchase transaction, determines whether each approving participant has sufficient funds to pay the amount to be charged associated with the participant, calculates a first calculated amount equal to an available balance in user's account added to a total amount to be charged associated with the approving participants (first amount), and calculates a second calculated amount equal to the available balance in the user's account subtracted from the amount of the purchase transaction. In some embodiments, the payment processing unit upon determinations that the first calculated amount is equal to or greater than the amount of the purchase transaction, and that the second calculated amount is equal to or less than user's pre-defined maximum participation amount, transfers the amounts to be charged associated with the approving participants to the user's account, and transfers the amount of purchase transaction from the user's account. In some embodiments, upon a determination that the unique/special password or PIN is not defined for the split payment definition, the payment processing unit performs the purchase transaction via a regular authorization process.

In some embodiments, when a payment card is not present, the payment processing unit receives a purchase transaction, performs a verification check specific to a financial instrument associated with the purchase transaction, determines whether the financial instrument is authorized to participate in the purchase transaction, upon a determination that the purchase transaction has been a marked for a split payment definition in a one-time password or a mobile application-based verification process, determines whether the split payment definition is active, and upon a determination that the split payment definition is active, determines whether there are any restrictions or rules that prevent performing purchase transaction. The payment processing unit determines whether each approving participant has sufficient funds to pay the amount to be charged associated with the participant, calculates a first calculated amount equal to an available balance in user's account added to a total amount to be charged associated with the approving participants (first total), calculates a second calculated amount equal to the available balance in user's account subtracted from the amount of the purchase transaction, upon determinations that the first calculated amount is equal to or greater than the amount of the purchase transaction, and that the second calculated amount is equal to or less than user's pre-defined maximum participation amount, transfers the amounts to be charged associated with the approving participants to the user's account, and transfers the amount of purchase transaction from the user's account. In some embodiments, payment processing unit determines whether the financial instrument is authorized to participate in the purchase transaction by determining whether the purchase transaction has been marked for a split payment definition in a one-time password or a mobile application-based verification method.

### BRIEF DESCRIPTION OF THE DRAWINGS

So that the present disclosure can be understood by those of ordinary skill in the art, a more detailed description can be had by reference to aspects of some illustrative embodiments, some of which are shown in the accompanying drawings.

FIG. 1A is a diagram showing an exemplary structure of account and split payment definition.

FIG. 1B is a diagram showing another exemplary structure of account and split payment definition.

FIG. 2 is a flowchart showing the process of creating the split payment definition.

FIG. 3 is a flowchart showing the working process of the host server (payment processing unit).

FIG. 4 is a flowchart showing an authorization process by the host server.

FIG. 5 is an exemplary topology diagram disclosed mission critical component and their location and connections for the invention.

FIG. 6 is an exemplary ecosystem diagram that shows mission critical components of the invention and other related integrations.

FIG. 7 is an exemplary application server modular diagram that shows mission critical modules of the invention and related integrations.

FIG. 8 and FIG. 18 are a unified modeling language (UML) diagram and a flowchart showing the process of processing a split payment create request, respectively.

FIG. 9 and FIG. 19 are a UML diagram and a flowchart showing the process of processing amount update request for a split payment definition, respectively.

FIG. 10 and FIG. 20 are a UML diagram and a flowchart showing the process of processing PIN change request for a split payment definition, respectively.

FIG. 11 and FIG. 21 are a UML diagram and a flowchart showing the process of processing parameter and restriction update request for a split payment definition, respectively.

FIG. 12 and FIG. 22 are a UML diagram and a flowchart showing the process of processing delete a participant request for a split payment definition, respectively.

FIG. 13 and FIG. 23 are a UML diagram and a flowchart showing the process of processing delete a split payment request, respectively.

FIG. 14 and FIG. 24 are a UML diagram and a flowchart showing the process of processing participant(s)′ amount update request for a split payment definition, respectively.

FIG. 15 and FIG. 25 are a UML diagram and a flowchart showing the process of processing a participant response of the split payment request, respectively.

FIG. 16 and FIG. 26 are a UML diagram and a flowchart showing the process of purchase transaction authorization with a split payment definition, respectively.

FIG. 17 and FIG. 27 are a UML diagram and a flowchart showing the process of online purchase transaction authorization with a split payment definition, respectively.

FIG. 28 describes how the transaction is separated as a split payment on the application server with unique/special PIN entrance on the terminal.

FIG. 29 illustrates a sample financial movement for a pre-defined split payment process before the purchase.

FIG. 30 and FIG. 31 illustrate sample financial movements for a pre-defined split payment process in purchase transaction time approved amount transfers from participants.

FIG. 32 illustrates an example graphical user interface (GUI) for adding participant for a pre-defined split payment.

FIG. 33 illustrates an example graphical user interface (GUI) for defining general parameters of a pre-defined split payment.

FIG. 34 illustrates an example graphical user interface (GUI) PIN Set of a pre-defined split payment.

FIG. 35 illustrates an example graphical user interface (GUI) Summary of a pre-defined split payment.

FIG. 36 illustrates an example graphical user interface (GUI) Edit of a pre-defined split payment.

FIG. 37 illustrates an example graphical user interface (GUI) Advance Definitions of a pre-defined split payment.

FIG. 38 illustrates an example graphical user interface (GUI) for participant approval of pre-defined split payment definition request.

FIG. 39 illustrates an example graphical user interface (GUI) for marking a card not present (CNP) transaction as a split payment during a mobile verification step.

FIG. 40 illustrates an example graphical user interface (GUI) for marking a card not present (CNP) transaction as a split payment during a One Time Password (OTP) verification phase. In accordance with common practice some features illustrated in the drawings cannot be drawn to scale. Accordingly, the dimensions of some features can be arbitrarily expanded or reduced for clarity. In addition, some of the drawings cannot depict all of the components of a given system, method or device. Finally, like reference numerals can be used to denote like features throughout the specification and FIG.s.

### DETAILED DESCRIPTION

In prior art, since relation between payment transaction and split payment definition could not be established directly, existing split payment solutions have been implemented with two different methods. One of the methods is to split the payment after the payment transaction is completed. The other method is to collect funds to an account in advance by making split payment definitions, then performing payment transaction by using the collected funds. Neither of these methods can directly establish a relation between payment transaction and split payment definition in the time of transaction. The present invention solves the problem of splitting payment at transaction time by defining a unique/special password for the payment transaction in the time of creating the split payment definition.

According to some embodiments of the present invention, there is no requirement for keeping the purchase amount on the owner of the split payment's personal account before the purchase. In purchase transaction time, the required amount can be transferred to split payment owner's account or can charge directly from participants' accounts. The owner of the split payment can track the participant status on a split payment and composing a decision for the purchase. Unlike the prior methods, disclosed split payment method is executed after the payment (i.e., the purchase) procedure is completed. Further, prior art discloses processes that are executed by using only existing card PIN. As such, there are no unique/special (additional) PIN(s) or password(s) for defining the split payment.

The present application discloses a split payment method in which before initiating the split payment process, a software application in mobile devices, or in any kind of computing device, is executed. The software application software defines, registers, and allows participation of all the users of the split payment users. Prior to executing the purchase transaction, the owner of the split payment defines a unique/special PIN or password for himself, and all participants registered and accepted to execute that split payment process.

In accordance with some embodiments of present disclosure, the split payment definition is performed before initiating the purchase transaction. In the present split payment system, the purchase transaction amount is charged from participant(s) during the transaction process (i.e., online).

In some embodiments of the present invention, defining a split payment request before a related transaction that has been performed, and a relationship between split payment definition and transaction are established. In some embodiments of the present invention, a specialized password for a specific split payment transaction is defined. In some embodiments of the present invention, a real time authorization from the participants for a split payment at transaction time is established.

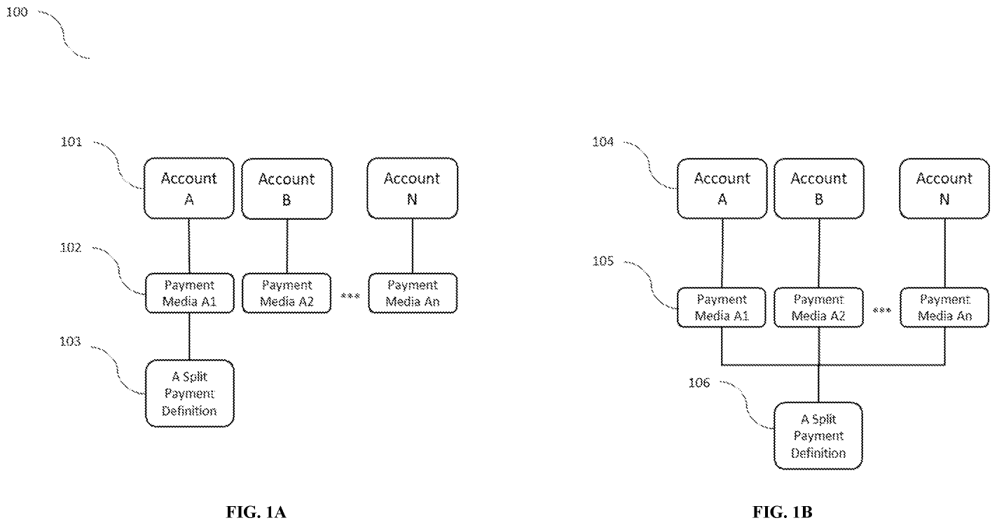

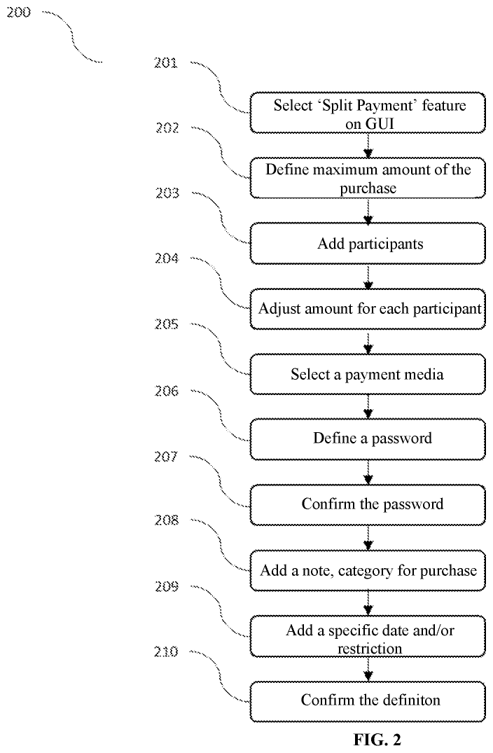

The structure of the invention allows the split payment to be initialized related to a specific instrument or independent from a payment instrument. A sample structure is illustrated in FIG. 1A and FIG. 1B. The split payment definition 103 is defined under a selected payment media (i.e., payment instrument) 102. In such a structure, a payment instrument selection is mandatory. That is, since the split payment definition 106 is not linked with a specific payment instrument, a payment instrument selection is not required. The split payment definition 103 is active for only a defined payment instrument 102. If the payment instrument is used with the split payment's defined password, the purchase is performed on the split payment. On the other hand, the split payment definition 106 does not include a specific payment instrument. In such embodiments, when a split payment's password detected for any payment instrument transaction, the purchase is performed on the split payment.

FIG. 2 illustrates an example flowchart diagram for selecting and creating a split payment definition. As shown in block 201, the user selects split payment before a purchase as an option. As shown in block 202, the user enters a maximum amount of the split payment that will be shared for each participant. As shown in block 203, the user enters participant's information with a unique identifier such as a mobile number, an account number. Alternatively, the user selects participant(s) from a contact list directly. The maximum amount is evenly distributed by payment processing unit for each participant. Optionally, the user can change participants' amount on a GUI, as shown in block 204. As shown in block 205, the user may optionally select a payment instrument that will be used for the related split payment purchase. Otherwise, payment processing unit can also check defined password of split payment for all payment instruments during the purchase transaction timeframe. As shown in block 206, a password is defined to establish relation between purchase transaction and split payment definition. The given password has to be unique to the split payment definition. The payment processing unit validates that the given password is not specified for a payment instrument or another split payment definition. If payment instrument not selected, the defined password must be different than all existing payment instruments' password and previously defined split payment definition's passwords. As shown in block 207, optionally, a password confirmation can be added for eliminating wrong password entry. Optionally, the user can add a note, tag, category for informing participants about purpose of the purchase, as shown in block 208. As shown in block 209, optionally, the user can add limitations such as date, date range, time, spending category, merchant, merchant category, location, blockage on participants' participation share amount. As shown in block 210, after providing required information and confirmation, the split payment definition is stored on the payment processing unit. The initial status of participants' is stored as “waiting”.

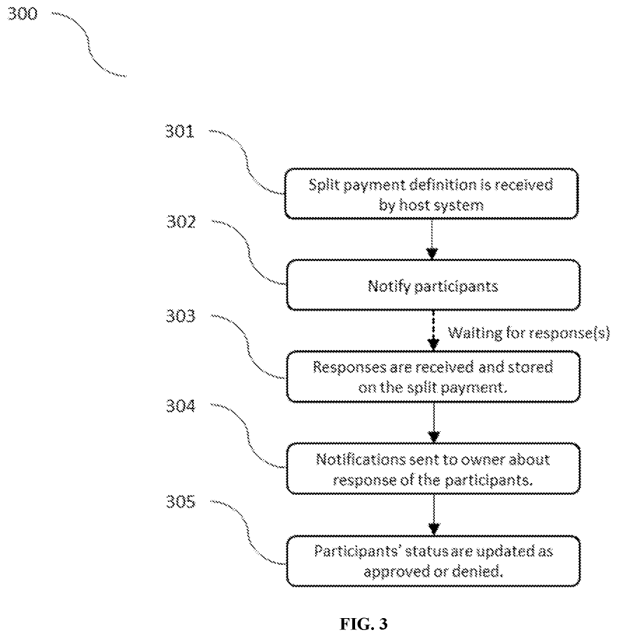

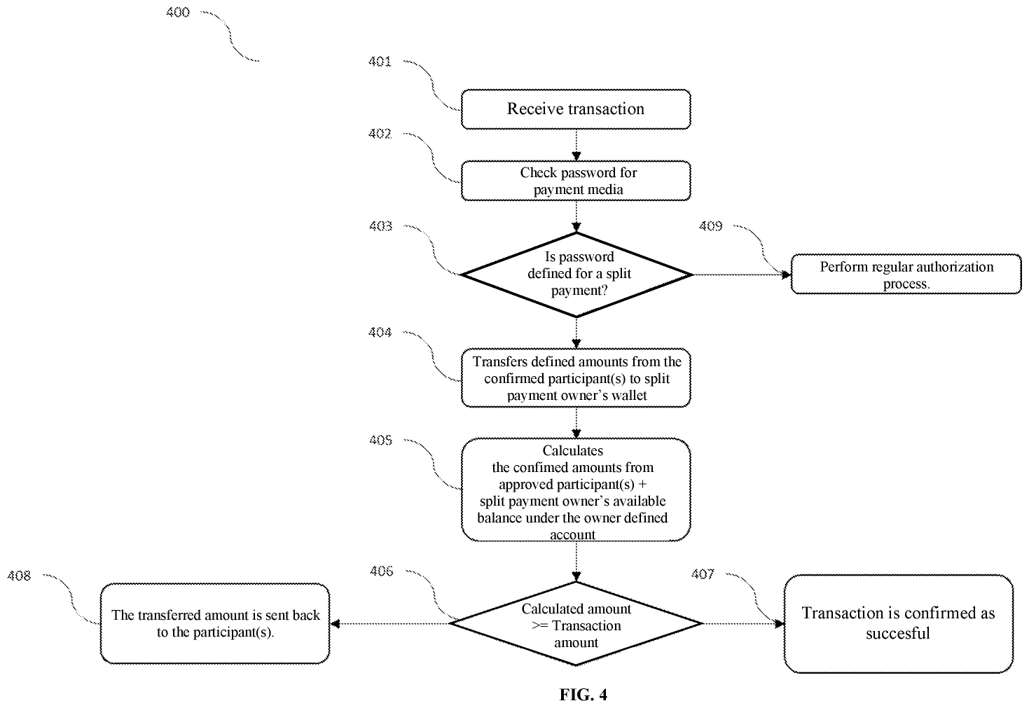

FIG. 3 illustrates an example flowchart diagram for performing the purchase transaction based on the split payment definition. As shown in block 301, when the split payment definition is received by host system (payment processing unit), the notifications are sent to participants on selected communication channel such as SMS, push notification, e-mail, web portal etc., as shown in block 302. As shown in block 303, when a response is received from the participant, the response is stored on the split payment definition. Participant can respond to the request as approve or deny. As shown in block 304, for each response, a notification is sent to the owner of the split payment. Approved participants' statuses are changed from “waiting” to “approved”. Similarly, denied participants' statuses are changed from “waiting” to “denied”, as shown in block 305.

FIG. 4 illustrates an example flowchart diagram for performing the purchase transaction based on the split payment definition. A purchase transaction can be transmitted from various channel such as a terminal, payment network, web portal, an API (Application Programming Interface), etc. As shown in block 401, whether the given password for the initiated transaction matches with a split payment password or not is checked. If the transaction password matches with a split payment password, as shown in block 403, at block 404, defined amounts from the approved participant(s) are transferred to split payment owner's wallet. As shown in block 405, a total successful transferred amount+split payment owner's available balance under the owner defined account is calculated. As shown in block 406, if the calculated amount is equal or greater from the transaction amount, then as shown in block 407, transaction is confirmed as successful, otherwise, as shown in block 408, the transferred amount is sent back to the participant(s). It should be noted that, if the transaction password does not match with a split payment password, then a regular authorization process is performed, as shown in block 409.

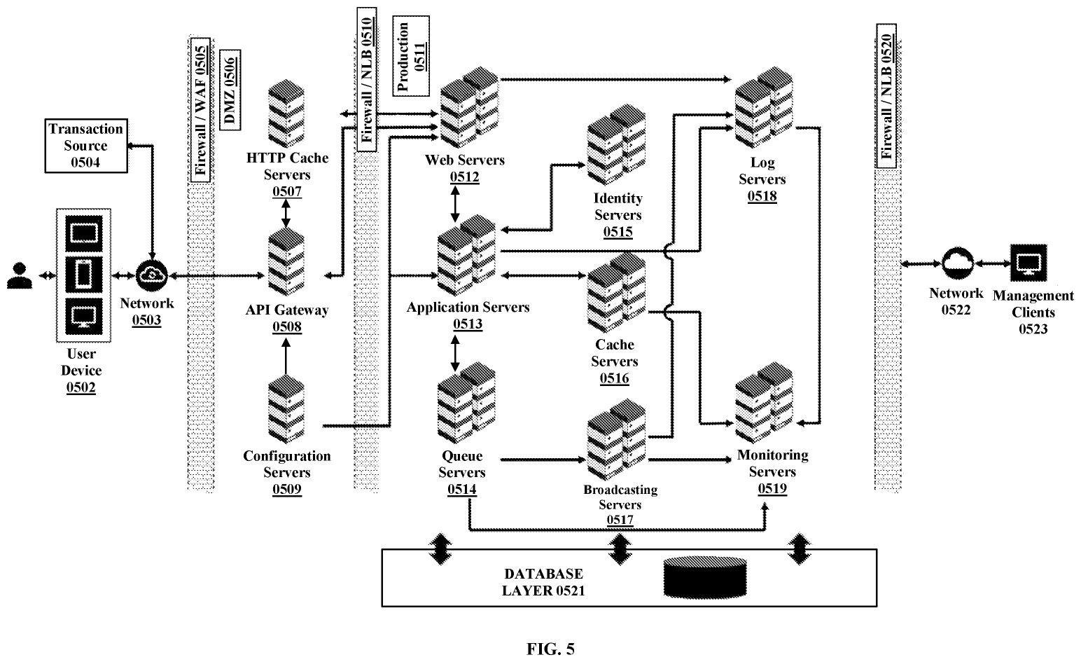

FIG. 5 illustrates an example topology diagram disclosed mission critical component and their location and connections for the invention. Various type of topology and modules may be implemented on multiple servers for the invention.

The user is illustrated as 0501. The user device 0502 can be a smartphone, tablet, laptop computer, desktop computer, game console, wearable smart device or any other device works with a processor, microprocessor, memory, user interface device, and network capabilities. Transaction Source 0504 represents a location where the transaction is made. The transaction source can be a psychical device or a software. (e.g., Point of Sale (POS), Virtual Point of sale (VPOS), a QR reader with a software, Mobile device) The network 0503, 0522 provides data transfer between main system and other related systems or devices. The communication may include wireless, wired or their combinations on a local area network (LAN), a wide area network (WAN), and any data communication (e.g., internet, intranet). Various communication protocols and layers may use, according to device, data and process-based requirements (e.g., Hypertext Transfer Protocol (HTTP), Transmission Control Protocol (TCP)/(Internet Protocol) IP (Internet Protocol), User Datagram Protocol (UDP).) Firewall 0505, 0510, 0520 is a technological barrier designed to prevent unauthorized or unwanted communications between computer networks or hosts. Web Application Firewall (WAF) 0505 is a web application firewall (WAF) is a specific form of application firewall that filters, monitors, and blocks HTTP traffic to and from a web service. By inspecting HTTP traffic, it can prevent attacks exploiting a web application's known vulnerabilities, such as SQL injection, cross-site scripting (XSS), file inclusion, and improper system configuration. The Network Load Balancer (NLB) 0510, 0520 is a device that distributes traffic across several servers by using the TCP/IP networking protocol. By combining two or more computers that are running applications into a single virtual cluster, NLB provides reliability and performance for web servers and other mission-critical servers. The demilitarized zone (DMZ) 0506 is a perimeter network that protects an organization's internal local-area network (LAN) from untrusted traffic.

A common DMZ meaning is a subnetwork that sits between the public internet and private networks. Production 0511 represents group of systems that used to process mission critical applications. Management clients 0523 represent application-based or browser-based management interfaces that works on a computing device with a processor, microprocessor, memory, user interface device and network capabilities. HTTP cache servers 0507 provide pre-optimized and cached results of HTTP requests for smooth client experience. API Gateway 0508 sits between a client and a collection of backend services and acts as a reverse proxy to accept all application programming interface (API) calls, aggregate the various services required to fulfill them, and return the appropriate result. Configuration servers 0509 store and provide all of the application settings for all environments (development, test and production). Web Servers 0512 manage, transmit and receive client requests on the World Wide Web (www). The primary function of the servers is to store, process and deliver web pages to clients. Application servers 0513 work with the web servers to handle requests for dynamic content, such as servlets, from web applications. The invention main modules and functions are located in application servers. Queue servers 0514 are used for inter-process communication (IPC), or for inter-thread communication within the same process. Identity servers 0515 are used for authentication and authorization of the clients. Cache servers 0516 provide copy of the business data for performance improvements and scalability. Broadcasting servers 0517 send SMS messages, e-mails and mobile notifications to the clients. Log servers 0518 store, analyze and show application logs for further investigations. Monitoring servers 0519 are used for monitoring system resources like CPU usage, memory consumption, I/O, network, disk usage, process and application metrics. Database 0521 is an organized collection of data, generally stored and accessed by computer applications such as SQL Server, Oracle, PostgreSQL, etc. Management Clients 0523 represents the authorized employees of the company that owns the system.

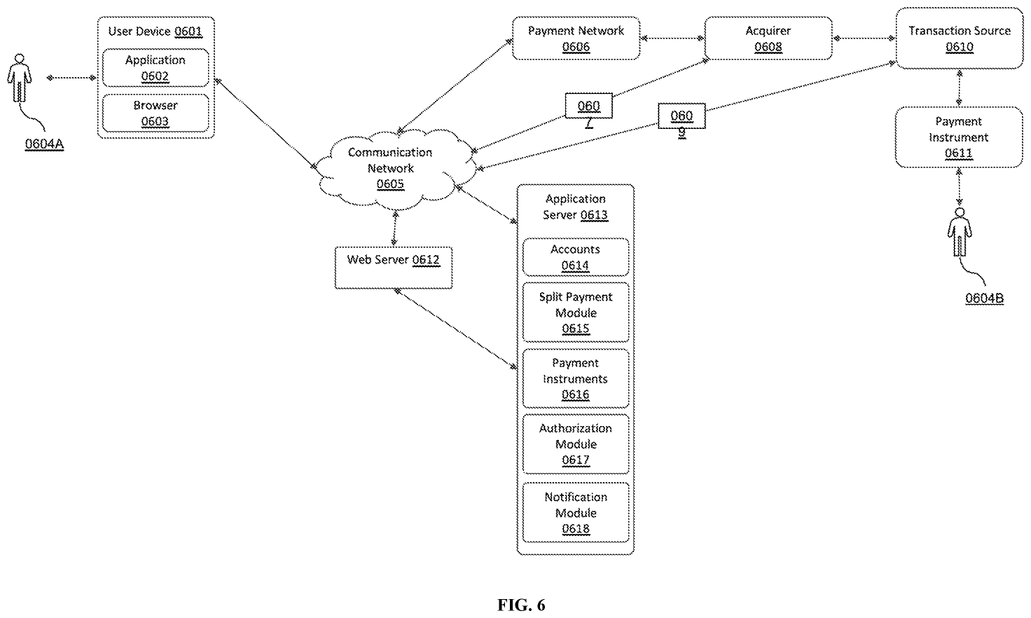

FIG. 6 illustrates an example ecosystem diagram that shows mission critical components of the invention and other related integrations. Graphical User Interfaces (GUIs) are provided for user activities. After the user 0604A logs in to the system, can use the provided pre-defined split payment functionality. GUIs can be displayed over 0602 an application or browser 0603 running on the device. The user device 0601 can be a smartphone, tablet, laptop computer, desktop computer, game console, wearable smart device or any other device works with a processor, microprocessor, memory, user interface device, and network capabilities. The communication network 0605 provides data transfer between main system and other related systems or devices. The communication may include wireless, wired or their combinations on a local area network (LAN), a wide area network (WAN), and any data communication (e.g., internet, intranet). Various communication protocols and layers may use, according to device, data and process-based requirements (e.g., Hypertext Transfer Protocol (HTTP), Transmission Control Protocol (TCP)/(Internet Protocol) IP (Internet Protocol), User Datagram Protocol (UDP).) Payment network 0606 represents a central institution's system that is responsible for managing, maintaining, reconciliation and settlement for all financial and transaction flow between financial institutions, devices, terminals and other parties under a schema. (e.g., Mastercard®, VISA® or domestic payment schemas). Acquirer 0608 represents a financial institution's system that processes payment instrument payments on behalf of a merchant and then settles the transaction with the payment instrument's issuer directly or via a payment scheme. Acquirer system transmits, receives electronic data between terminal and other financial institutions. If the financial instrument does not belong to a schema, transactions 0607 can transmit directly from the acquirer.

Terminals can send transactions directly to Application Server 0609. If the financial instrument belongs to a schema, the transactions will be sent to the relevant payment network and reach the main system through it. Transaction Source 0610 represents a location where the transaction is made. The transaction source can be a psychical device or a software (e.g., Point of Sale (POS), Virtual Point of sale (VPOS), a QR reader with a software, Mobile device). Payment instrument 0611 represent a digital or physical personalized device(s) and/or set of procedures and used in order to initiate a payment order. (e.g., smart card, virtual card, QR code, Near Field Communication (NFC) contactless card, mobile payment device). Application Server 0613 represents the physical environment in which the main software of the invention runs. The invention main modules run on physical servers that have the ability to connect to the network, have a processor and memory. The invention can run as “On-Premises” as well as in different configurations such as Infrastructure as a Service (IaaS), Platform as a Service (PaaS), Software as a Service (SaaS). Web Servers 0612 manage, transmit and receive client requests on the World Wide Web (www). The primary function of the servers is to store, process and deliver web pages to clients.

Authorization module 0617 is responsible for generating a response for incoming transaction message. Payment instrument module 0616 keeps account and payment instrument relations with assignments. Accounts 0614 holds all account information with balances and cardholder information. Split payment module 0615 includes sub-modules that enable transactions within the pre-defined split payment lifecycle. Notification module 0618 is responsible for sending a notification to users by an SMS, email, push notification for mobile or web etc.

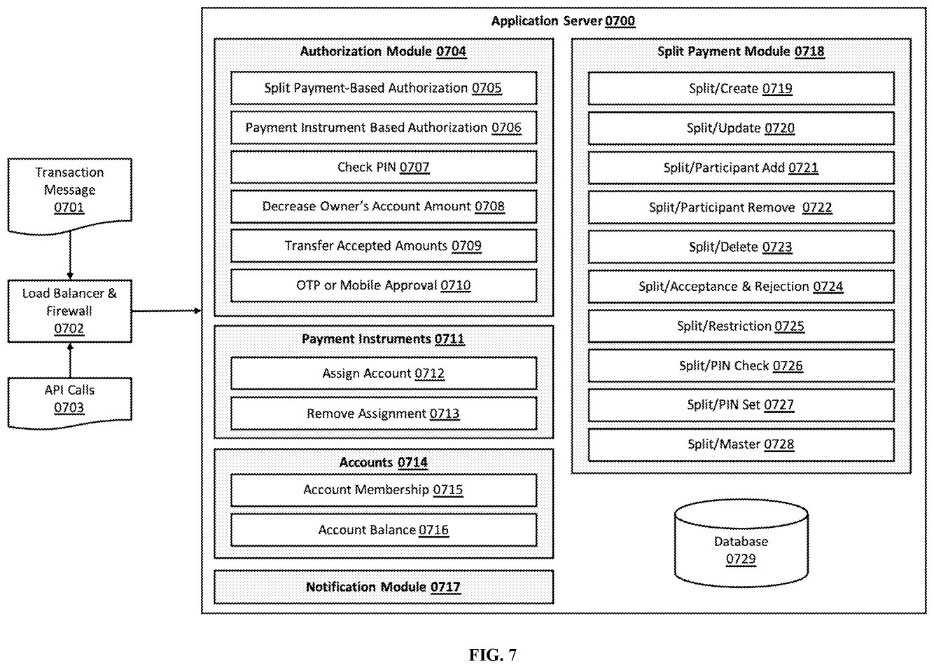

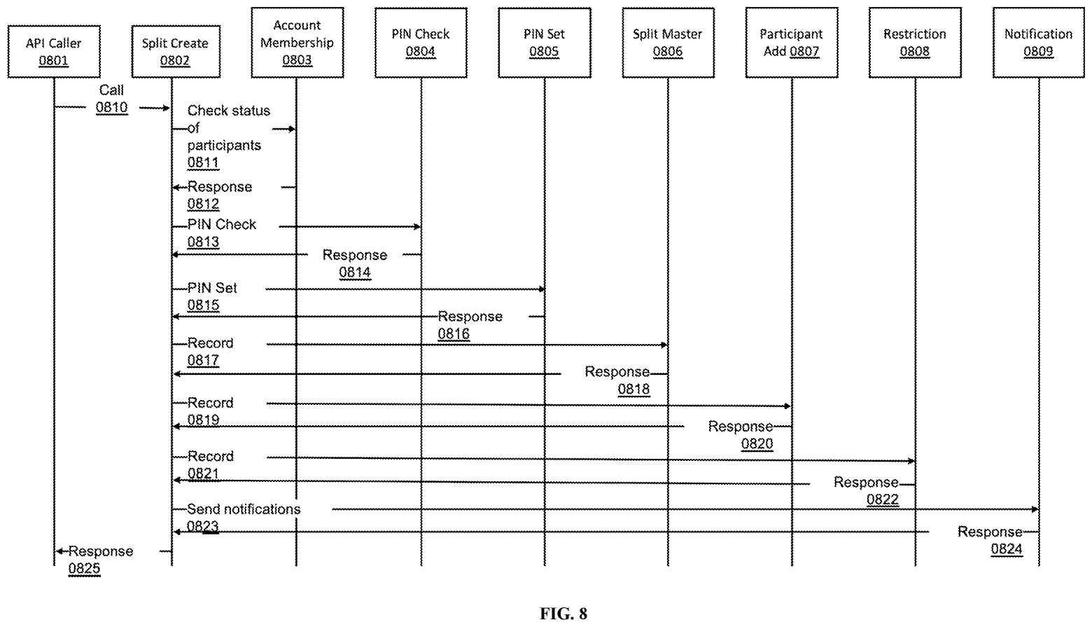

FIG. 7 illustrates an example application server modular diagram that shows mission critical modules of the invention and related integrations. Transaction message 0701 represents financial transactions such as purchase. The transaction can be transmitted by a payment network, acquirer or directly from a transaction source such as a POS, Virtual POS. The format and the data communication type can be configurable according to the financial instrument schema or process. Firewall 0702 is a technological barrier designed to prevent unauthorized or unwanted communications between networks and production servers. Load balancer 0702 distributes traffic across several servers according to data load. API Calls 0703 can be initiated by directly a client application on a user device or a browser. Authorization module 0704 is responsible for generating a response for incoming transaction message. Payment instrument and transaction authentication, PIN or password authentication, deducting an amount from an available balance, one-time password or mobile app verification controls and pre-defined split payment specific verification process are handled by the authorization module. Payment instrument-based authorization 0706 is a sub service of authorization module responsible for payment instrument specific controls and authentication such as payment instrument's cryptograms, certificates. Check PIN 0707 is the module that authenticates of the personal identification number (PIN) received in the incoming transaction. If the PIN matches to a pre-defined split payment transaction, the authorization module detects “unique/special PIN” and triggers to pre-defined split process. Split payment-based authorization 0705 is a sub service of the main authorization module responsible for managing split payment authorization process. The “decrease owner's account amount” service 0708 deducts the transaction amount from pre-defined split payment owner. During a pre-defined split payment transaction, “Transfer accepted amounts” 0709 module transfers the accepted amounts to the owner of the pre-defined split payment from the participants accounts in the transaction time. “OTP or Mobile Approval” service 0710 is responsible for card not present (CNP) transaction verification with One Time Password (OTP) or mobile application. Card not present transaction (CNP) is a payment card transaction made where the cardholder does not or cannot physically present the card at the transaction time. It is most commonly used for payments made over internet for ecommerce.

In the verification, the “OTP or Mobile Approval” service also provides split payment information, if the transaction is marked as “a split payment”. Payment instrument module 0711 keeps account and payment instrument relations with assignments. A financial instrument and an account can be linked by Assign Account 0712. An existing card and account assignment can be removed by Remove Assignment 0713. These assignments provide information on which account to use when using a financial instrument.

Accounts 0714 holds all account information with balances and cardholder information. Account membership 0715 service checks the existence of the account holder, eligibility for that transaction, then returns the necessary information. Account balance 0716 service checks whether there is sufficient balance in the relevant account for a transaction or split payment sub process. Notification module 0717 is responsible for sending a notification to users by an SMS, email, push notification for mobile or web etc. Split payment module 0718 includes sub-modules that enable transactions within the pre-defined split payment lifecycle. Split payment module includes all record creation, update, delete, approvals and controls related to a pre-defined split payment. Split payment module also works with the main authorization module 0704 during a purchase transaction authorization. Split/Create 0719 receives a pre-defined split payment creation request and manages the creation process on the system. Split/Update 0720 is responsible for the management of all updates in an existing pre-defined split payment. Split/Participant Add 0721 allows to add participant in a pre-defined split payment in during creation phase. Split/Participant Remove 0722 allows removal of a participant on an existing pre-defined split payment. Split/Restriction 0725 enables to define the restriction on a pre-defined split payment. Split/Delete 0723 performs deletion of an existing pre-defined split payment. Split/Acceptance & Rejection 0724 allows the participant to be included in a pre-defined split payment or not, based on the participant response for a pre-defined split payment. Split/PIN Check 0726 checks whether a PIN designated for a pre-defined split payment has been previously defined on the card as a regular card PIN. Split/Pin Set 0727 ensures that the PIN determined for a pre-defined split payment is saved in relation to the selected payment instrument. Split/Master 0728 is responsible for generation of main records of a pre-defined split payment. Database 0729 stores all records, logs, updates, transactions, accounts, financial instruments.

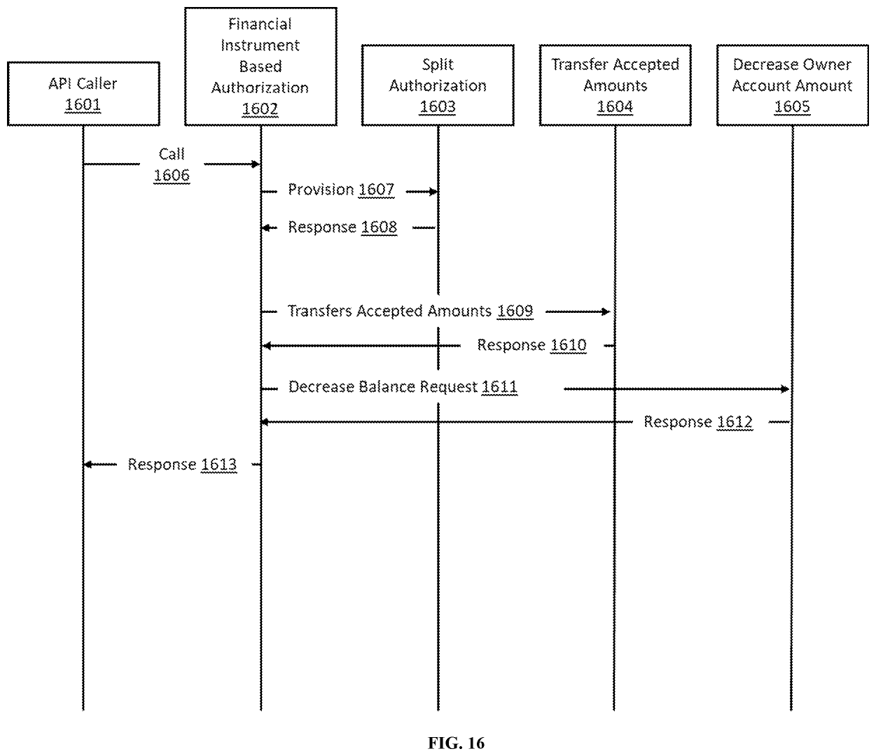

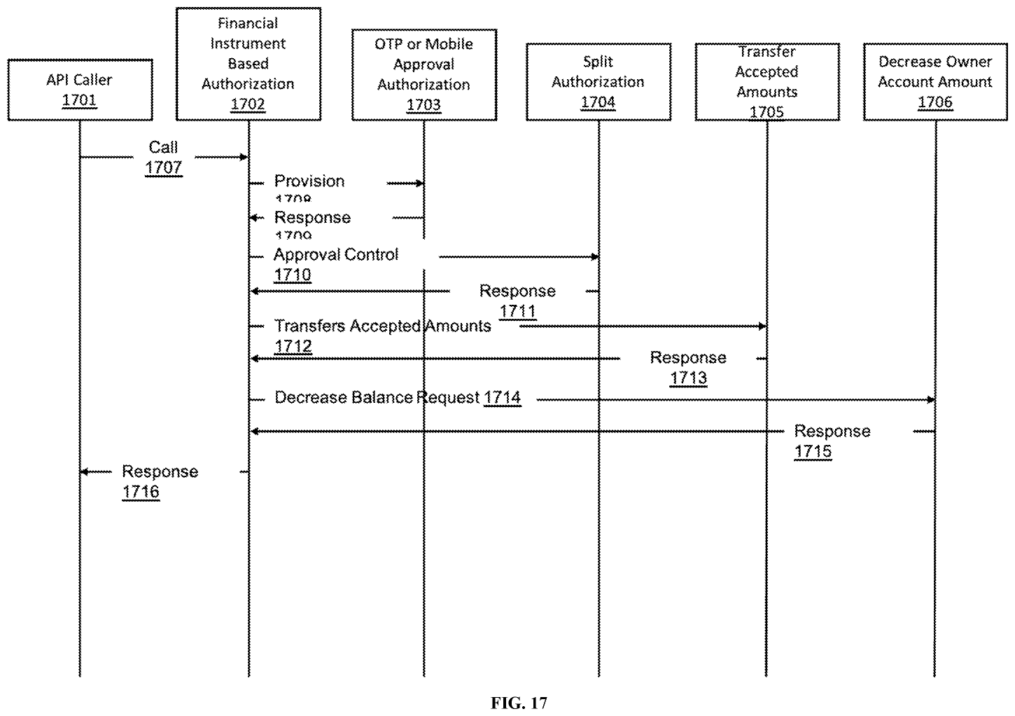

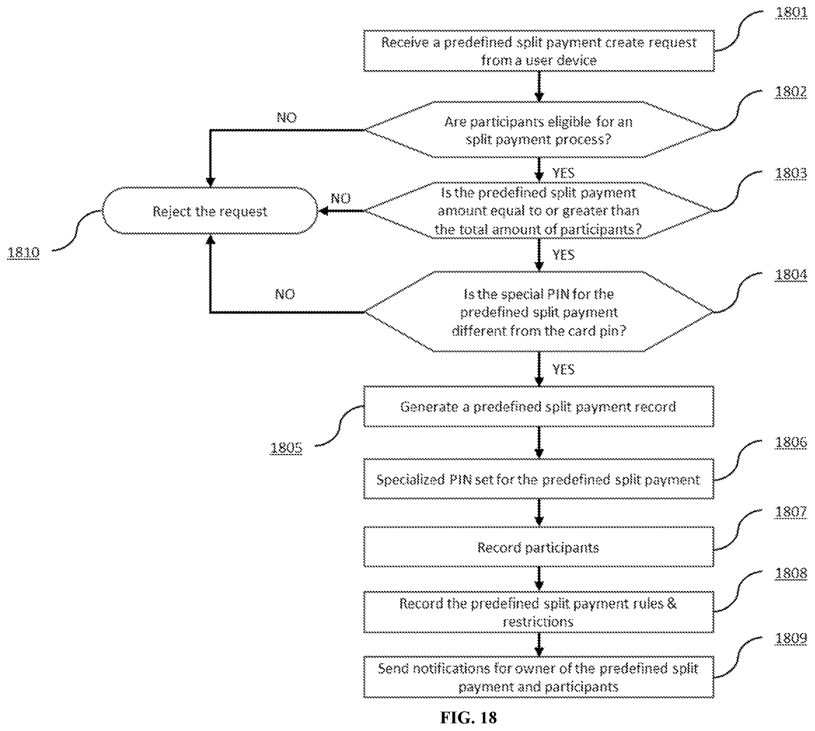

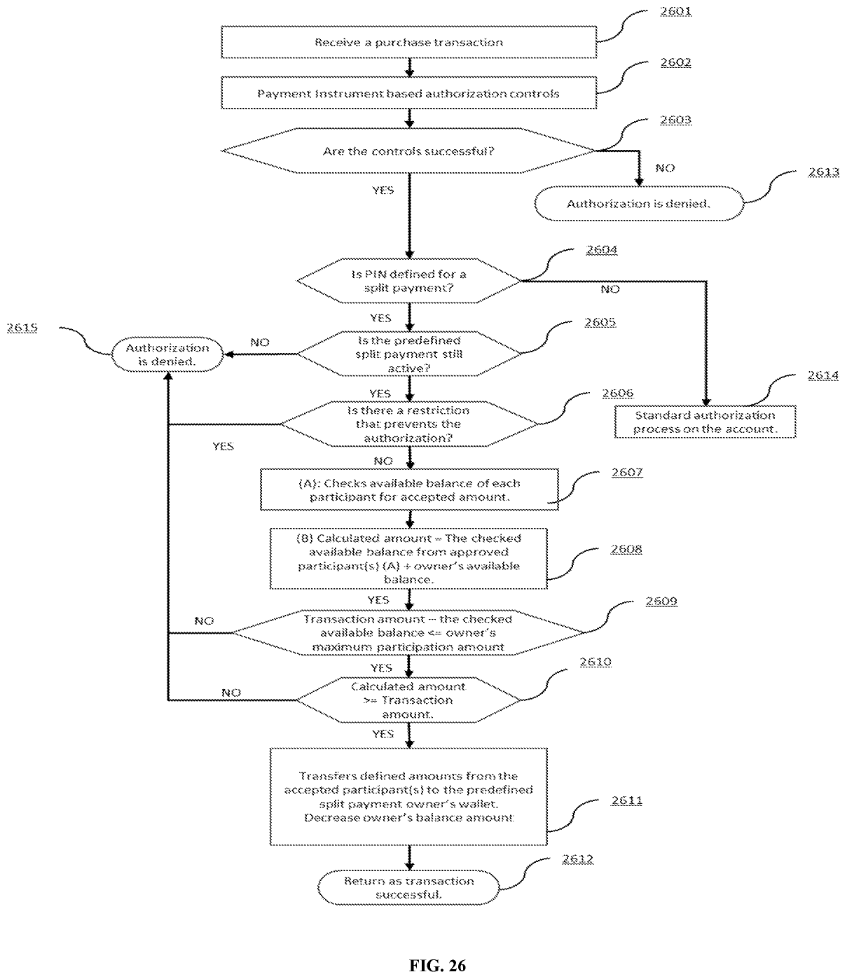

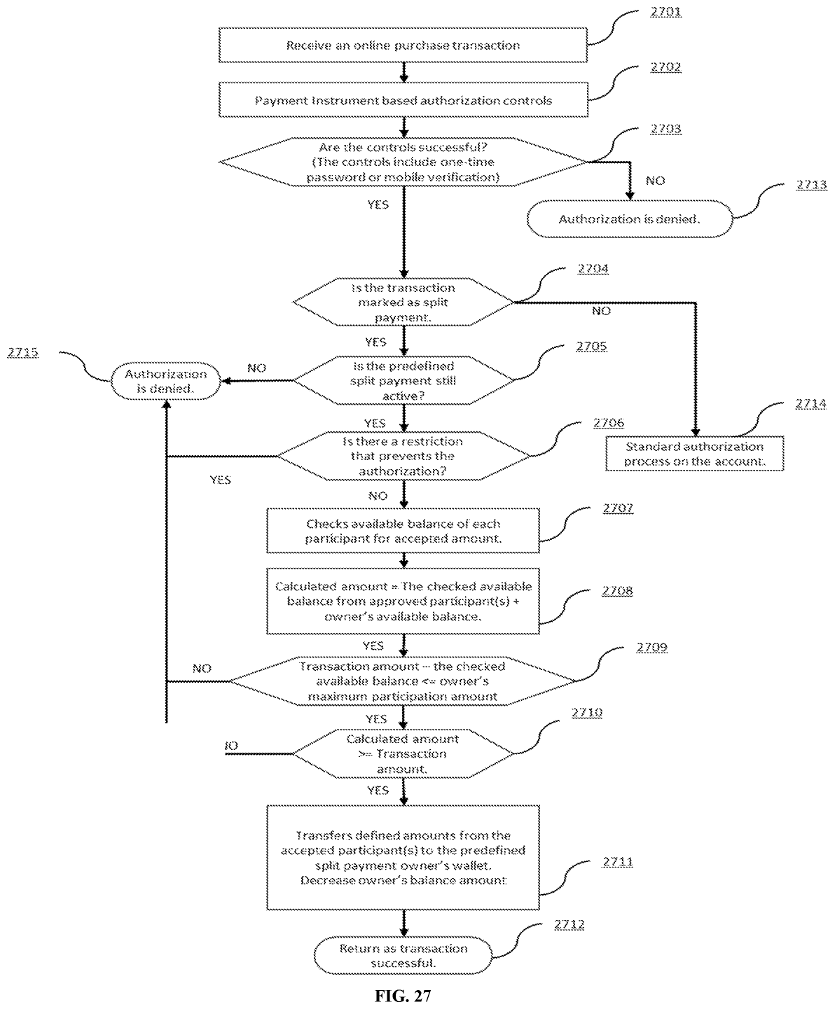

In this section, technical details about the components of the system, their relationship and functioning are described. The specialized split payment infrastructure mentioned in the invention will be stated as “pre-defined split payment” or “split payment processing”. The authorization process described in FIG. 4 is expanded with the alternatives in FIG. 26 and FIG. 27 and their UML diagrams in FIG. 16 and FIG. 17. The UML diagrams described in FIGS. 8-17 are explained with the business flows described in FIGS. 18-27. The relationship between UML diagrams and workflows is described below.

FIG. 8 and FIG. 18 is related and are about processing a pre-defined split payment create request.

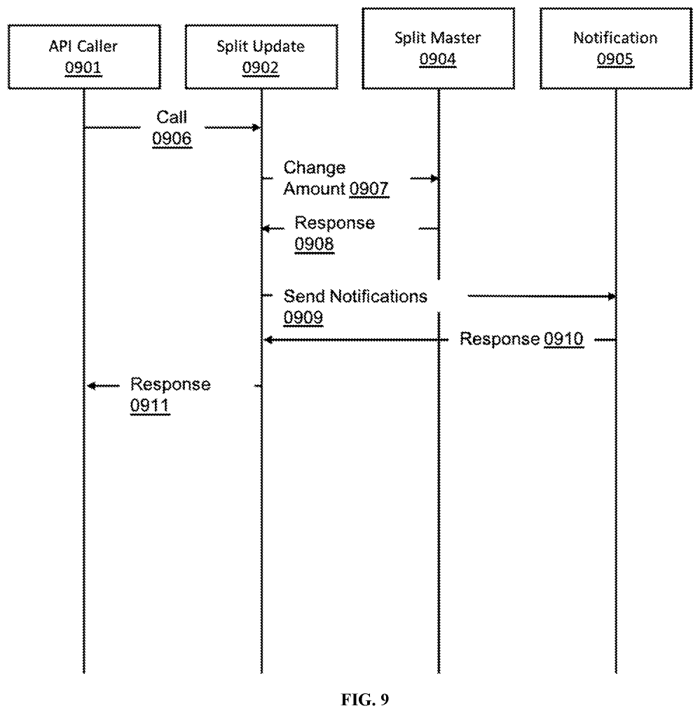

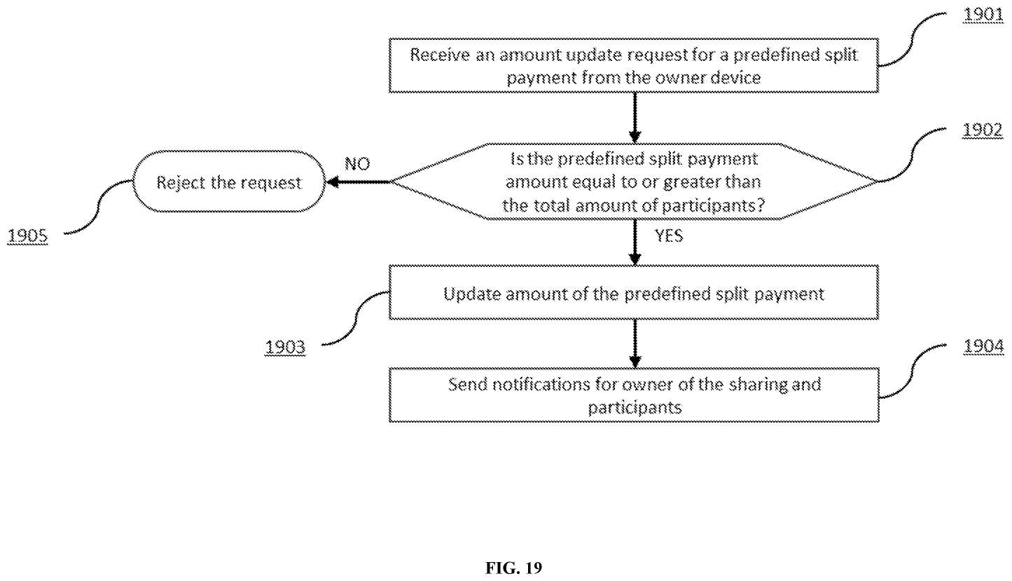

FIG. 9 and FIG. 19 is related and are about processing amount update request for a pre-defined split payment.

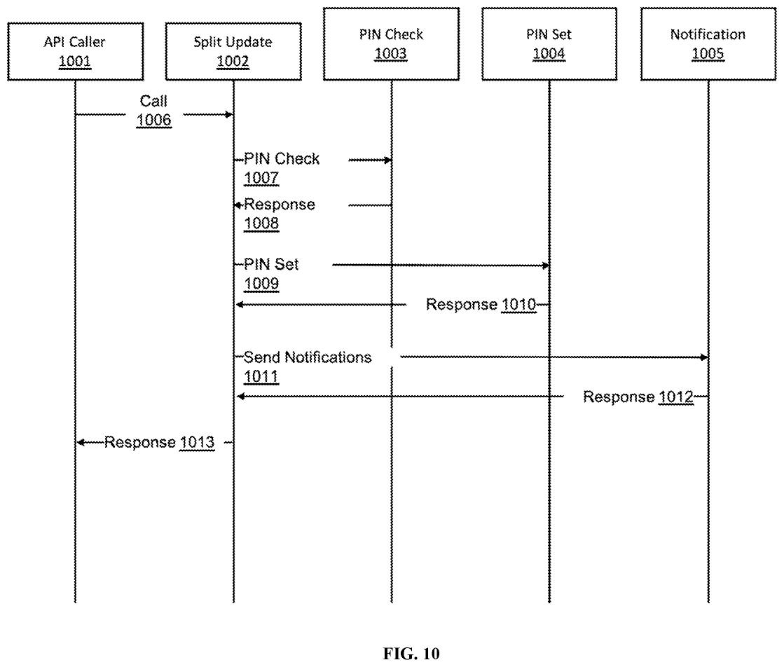

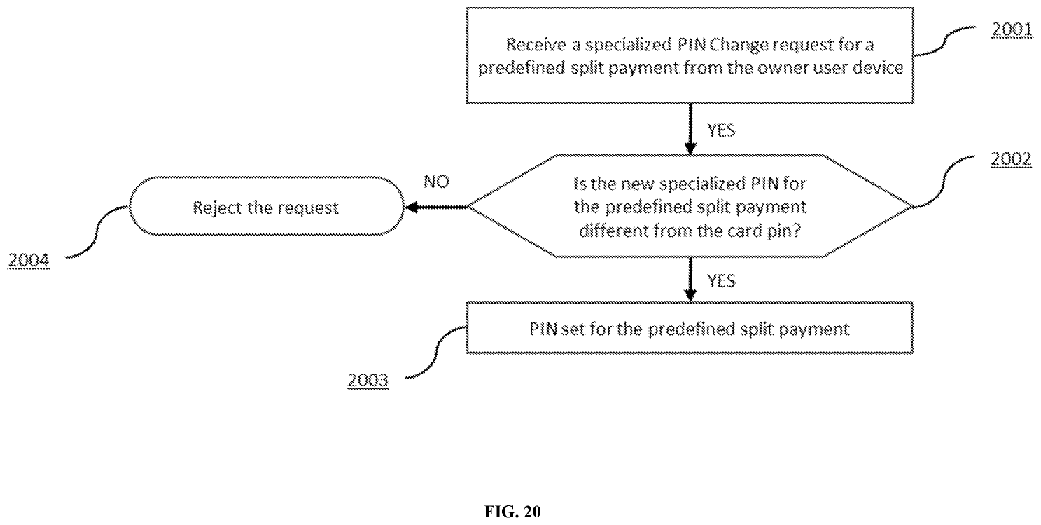

FIG. 10 and FIG. 20 is related and are about processing PIN change request for a pre-defined split payment.

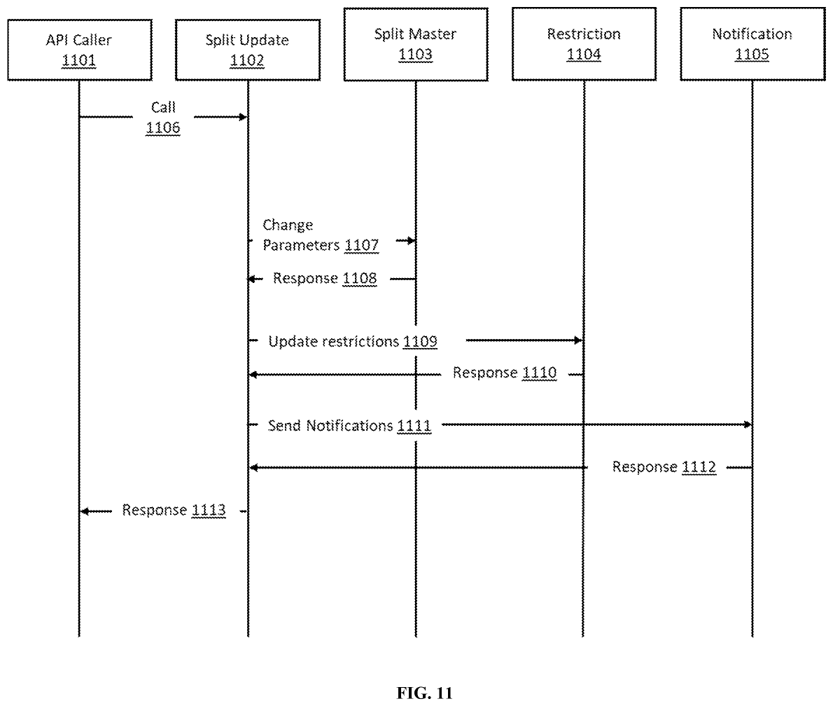

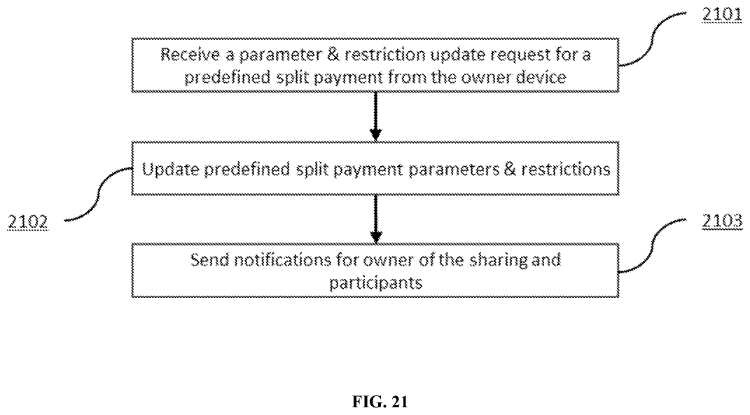

FIG. 11 and FIG. 21 is related and are about processing parameter and restriction update request for a pre-defined split payment.

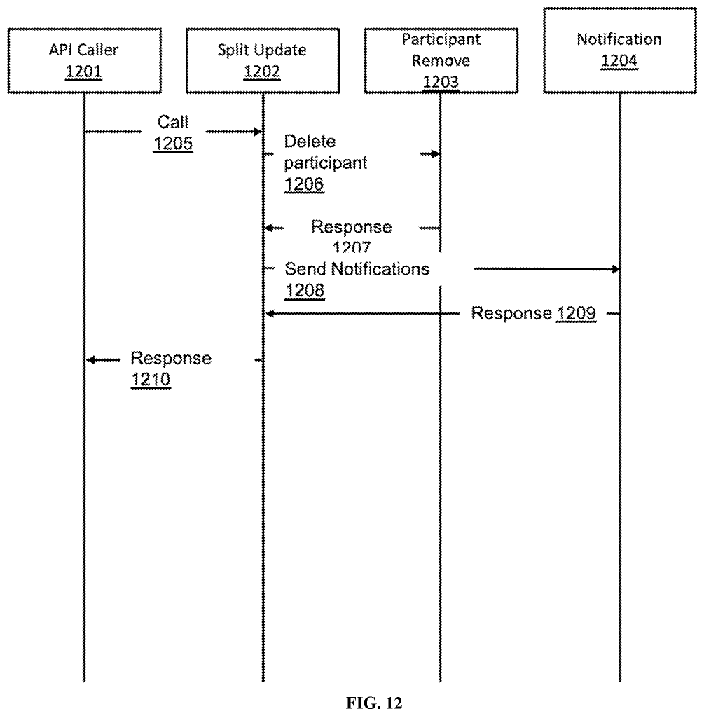

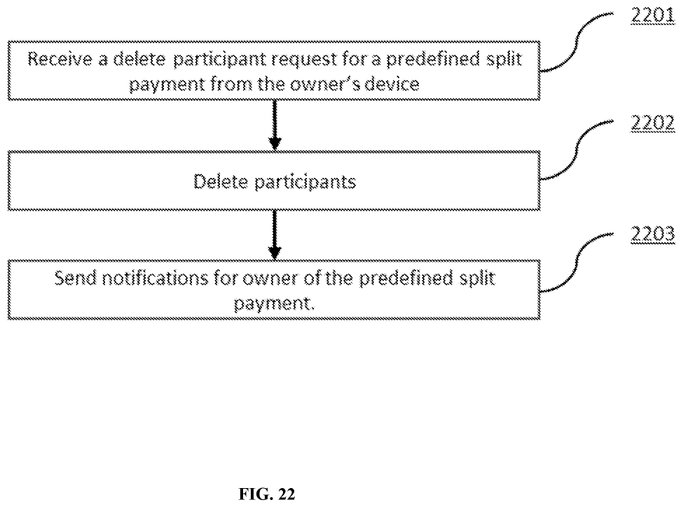

FIG. 12 and FIG. 22 is related and are about processing delete a participant request for a pre-defined split payment.

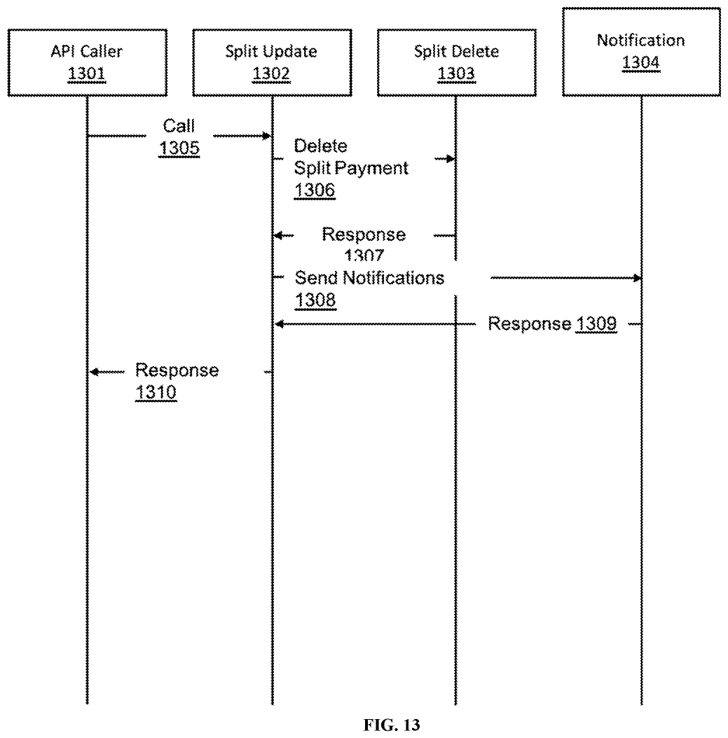

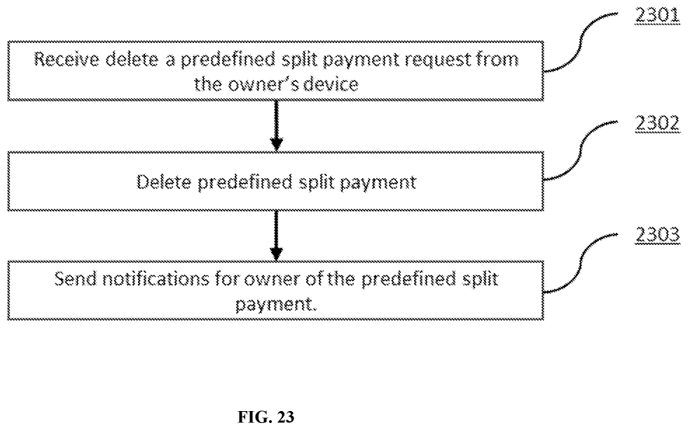

FIG. 13 and FIG. 23 is related and are about processing delete a pre-defined split payment request.

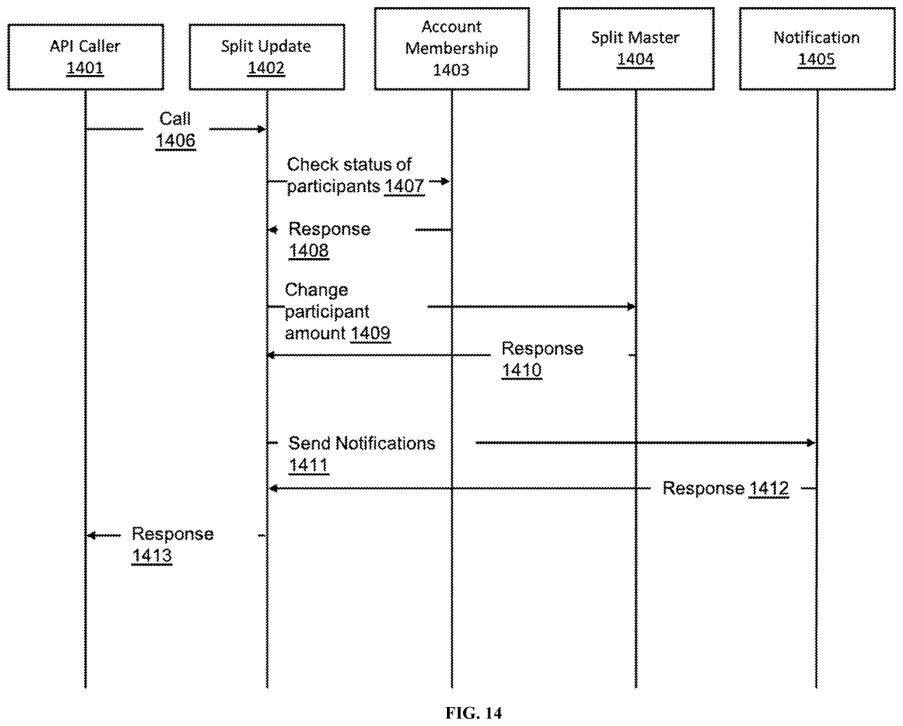

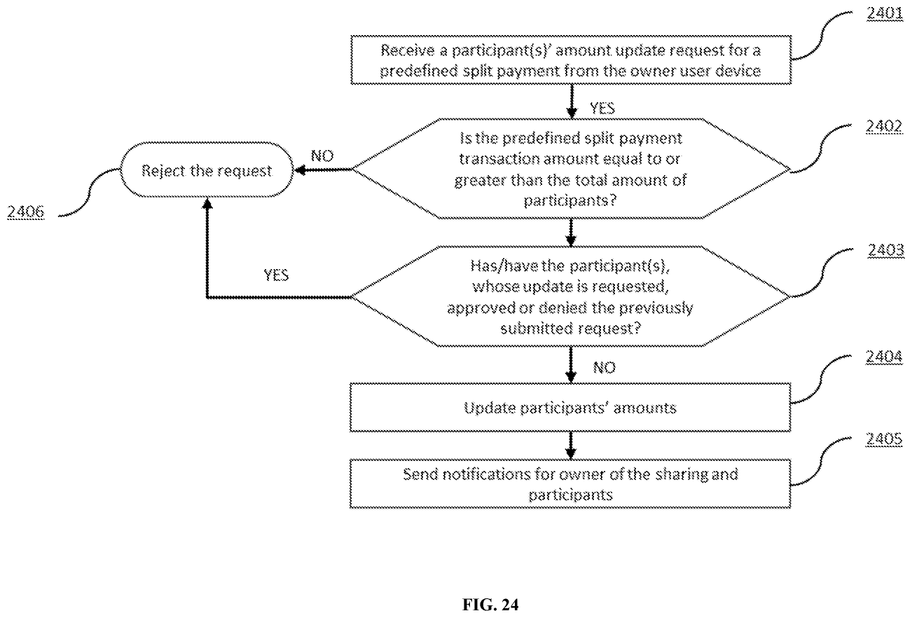

FIG. 14 and FIG. 24 is related and are about processing participant(s)′ amount update request for a pre-defined split payment.

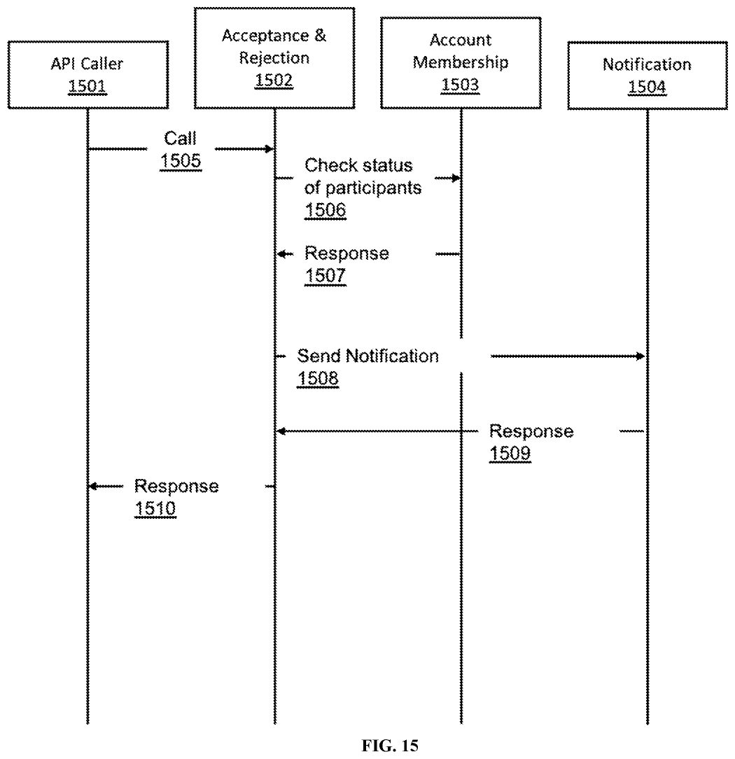

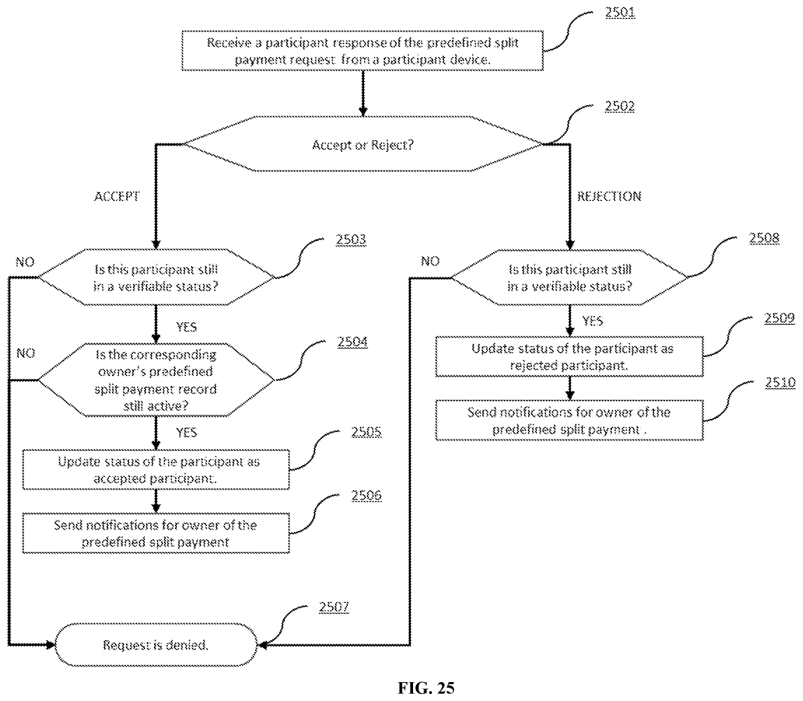

FIG. 15 and FIG. 25 is related and are about processing a participant response of the pre-defined split payment request.

FIG. 16 and FIG. 26 is related and are about purchase transaction authorization with a pre-defined split payment.

FIG. 17 and FIG. 27 is related and are about online purchase transaction authorization with a pre-defined split payment.

In the process, the life cycle of a pre-defined split payment process is explained through the sample flows. In this process, many optional features are explained. The optional and essential processes are listed below.

Create process is essential that is described in FIG. 8, FIG. 18.

Purchase process is essential that is described in FIG. 16, FIG. 26.

There may be changes in the processes and sequences described in business flows or UML diagrams, but the basically created functionality will not change.

FIG. 8 illustrates an example sequence diagram for a creation of a pre-defined split payment. API Caller 0801 calls 0810 Split Create 0802 service for initiating the pre-defined split payment create process. Share Create service 0802 calls 0811 Account Membership service 0803 for checking participant status for eligibility. If the participant(s) do not exist or do not meet the conditions being a participant for a pre-defined split payment, the request is rejected 0812. If the participants meet the conditions, the approval response 0812 is returned to the Split Create 0802 service. Split Create 0802 service checks whether the main amount defined for the predefined split payment is greater than or equal to the total amount of the participants. If the amounts do not comply, the request is denied 0825. If the amounts are compatible, the process continues. If the previous step is successful, the payment processing unit checks whether the unique/special PIN defined for the predefined split payment is different from the current card PIN with calling PIN Check 0813. If the PINs are not different, the definition is rejected 0814. If the PINs are different, the unique/special PIN defined on the created pre-defined split payment record is stored by calling PIN Set service 0815.

If the records are not created during the following records, the called service will return an error (0816, 0818, 0820, 0822). If the records are created, a successful response (0816, 0818, 0820, 0822) is returned.

Split Create 0802 calls PIN set 0805 service for recording unique/special PIN. Split Create 0802 calls Split Master 0806 service for recording split payment parameters such as transaction amount, note, blockage of confirmed amount from participant's account. Split Create 0802 calls Participant Add 0807 service for adding defined participant on the pre-defined split payment. Split Create 0802 calls Restriction 0808 service for recording restriction definitions such as expire date, maximum amount of the owner, transaction restriction profile that can be include sector, sector group, specific merchant, location. Split Create 0802 calls Notification 0809 service for sending notification to relevant persons.

In the process, if there is a situation that prevents the creation of a pre-defined split payment record, a rejection response 0825 is returned to API caller 0801. If a pre-defined split payment record (i.e., a split payment definition) is created, a successful response 0825 is returned.

In all update transactions, the request must come from the owner's device (owner of the pre-defined split payment). The payment processing unit performs the relevant verification controls in these processes.

FIG. 9 illustrates an example sequence diagram changing defined amount of a pre-defined split payment.

API Caller 0901 calls 0906 Split Update 0902 service for initiating changing defined amount of a pre-defined split payment process. Split Update 0902 service checks whether the main amount defined for the predefined split payment is greater than or equal to the total amount of the participants. If the amounts do not comply, the request is denied 0911. If the amounts are compatible, the process continues. If the previous step is successful, Split Update 0902 service calls 0907 Split Master 0904 for changing the transaction amount of the related pre-defined split payment. If the amount is updated, Split Master 0904 returns as successful 0908. If the amount cannot be updated, Split Master returns a rejection 0908. Split Update 0902 calls 0909 Notification 0905 service for sending notification to owner of the split payment. Notification 0905 service returns notification status as a response 0910.

In the process, if there is a situation that prevents the update of a pre-defined split payment record, a rejection response 0911 is returned to API caller 0901. If a pre-defined split payment record is updated, a successful response 0911 is returned.

FIG. 10 illustrates an example sequence diagram changing defined unique/special PIN of a pre-defined split payment.

API Caller 1001 calls 1006 Split Update 1002 service for initiating changing defined unique/special PIN of a pre-defined split payment process. Split Update 1002 calls PIN Check 1003 service for checking the new PIN is compatible. PIN Check 1003 service determinates whether the unique/special PIN defined for the predefined split payment is different from the current card PIN. If the PINs are not different, the update request is rejected 1008. If the PINs are different, Split Update 1002 service calls 1009 PIN Set 1004. If the unique/special PIN defined is updated on the existing pre-defined split payment record and successful response is returned 1010. If the PIN is not updated by PIN Set service, The PIN set service returns as rejected 1010. Split Update 1002 calls 1011 Notification 1005 service for sending notification to owner of the split payment. Notification 1005 service returns notification status as a response 1012.

In the process, if there is a situation that prevents the update of a pre-defined split payment record, a rejection response 1013 is returned to API caller 1001. If a pre-defined split payment record is updated, a successful response 1013 is returned.

FIG. 11 illustrates an example sequence diagram for updating parameters & restrictions of a pre-defined split payment. API Caller 1101 calls 1106 Split Update 1102 service for updating parameters & restrictions of a pre-defined split payment process.

If the records are not updated during the following steps, the called service will return an error (1108, 1110). If the records are updated, a successful response (1108, 1110) is returned. Split Update 1102 calls Split Master 1103 service for recording split payment parameters such as note, blockage of confirmed amount from participant's account. Split Update 1102 calls Restriction 1104 service for recording restriction definitions such as expire date, maximum amount of the owner, transaction restriction profile that can be include sector, sector group, specific merchant, location. Split Update 1102 calls Notification 1105 service for sending notification to relevant persons.

In the process, if there is a situation that prevents the update of a pre-defined split payment record, a rejection response 1113 is returned to API caller 1101. If a pre-defined split payment record is updated, a successful response 1113 is returned.

FIG. 12 illustrates an example sequence diagram for deleting a participant of an existing pre-defined split payment.

API Caller 1201 calls 1205 Split Update 1202 service for deleting a participant of an existing pre-defined split payment. Split Update 1202 calls 1206 Participant Remove 1203 service for deleting the participant. If the participant is deleted on the pre-defined split payment definition, Participant Remove 1203 service returns as successful 1207. If the participant cannot be deleted, Participant Remove 1203 service returns a rejection 1207. Split Update 1202 calls 1208 Notification 1204 service for sending notification to owner of the split payment and the deleted participant. Notification 1204 service returns notification status as a response 1209.

In the process, if there is a situation that prevents deleting the participant, a rejection response 1210 is returned to API caller 1201. If the participant is deleted, a successful response 1210 is returned.

FIG. 13 illustrates an example sequence diagram for deleting an existing pre-defined split payment.

API Caller 1301 calls 1305 Split Update 1302 service for deleting an existing pre-defined split payment. Split Update 1302 calls 1306 Split Delete 1303 service for deleting the pre-defined split payment. If the pre-defined split payment is deleted, Split Delete 1303 service returns as successful 1307. If the pre-defined split payment cannot be deleted, Split Delete 1303 service returns a rejection 1307. Split Update 1302 calls 1308 Notification 1304 service for sending notification to owner of the split payment and the related participant(s). Notification 1304 service returns notification status as a response 1309.

In the process, if there is a situation that prevents deleting the pre-defined split payment, a rejection response 1310 is returned to API caller 1301. If the pre-defined split payment is deleted, a successful response 1310 is returned.

FIG. 14 illustrates an example sequence diagram for updating a participant amount of an existing pre-defined split payment.

API Caller 1401 calls 1406 Split Update 1402 service for updating a participant amount of an existing pre-defined split payment. Split Update 1402 calls 1407 Account Membership 1403 service for checking participant approval status and updating the defined amount.

Account Membership 1403 service checks whether the participant to be updated has approved the previously submitted request. If the participant to be updated has approved or denied the previously submitted request, the request is rejected 1408. As an alternative to the rejection of the update process, the participant may be asked to confirm the changed amount. If the participant status is waiting, Split Update 1402 calls 1409 Split Master 1404 for updating the participant amount. If the participant amount is updated, Split Master 1404 returns as successful 1410. If the participant amount is not updated, Split Master 1404 returns a rejection 1410. Split Update 1402 calls 1411 Notification 1405 service for sending notification to owner of the split payment and the related participant. Notification 1405 service returns notification status as a response 1412.

In the process, if there is a situation that prevents the update of the participant amount, a rejection response 1413 is returned to API caller 1401. If the participant amount is updated, a successful response 1413 is returned.

FIG. 15 illustrates an example sequence diagram for acceptance & rejection of a participant in a pre-defined split payment process.

API Caller 1501 calls 1505 Acceptance & Rejection 1502 service for updating participant status according to the participant's response.

Acceptance & Rejection 1502 service calls 1506 Account Membership 1503 for checking the status of the participant. If the participant does not exist or the participant status is rejected or approved, the request is rejected 1507. In the status control, the pre-defined split payment general status is controlled. The pre-defined split payment record must be active. Otherwise, the request is rejected 1507. If the participant is eligible and participant status is waiting, the status of the participant is updated with the status specified in the request and the successful result is returned 1507.

Acceptance & Rejection 1502 calls 1508 Notification 1504 service for sending notification to owner of the split payment and the related participant. Notification 1404 service returns notification status as a response 1509.

In the process, if there is a situation that prevents the update of the participant status, a rejection response 1510 is returned to API caller 1501. If the participant status is updated, a successful response 1510 is returned.

FIG. 16 illustrates an example sequence diagram for processing a purchase transaction (Card Present) on a pre-defined split payment.

API Caller 1601 calls 1606 Financial Instrument-Based Authorization 1602 service for authorization of the CP (Card Present) purchase transaction. Financial Instrument-Based Authorization 1602 performs the following controls, financial instrument-based verification checks, determinate whether the PIN has been defined for a pre-defined split payment.

If the financial instrument-based verifications are failed, the transaction is denied directly 1613. If the PIN is not defined for a pre-defined split payment, the transaction proceeds with the regular authorization process. The regular authorization process is out of the scope.

If the PIN is defined for a pre-defined split payment, Financial Instrument-Based Authorization 1602 calls 1607 for provision. Split Authorization 1603 performs the following controls: D\ determines whether the pre-defined split payment is active, and checks if there is any restriction that prevents the transaction.

If any of these checks fail, a rejection response is sent 1608. If these two checks are successful, the calculation step is initialized.

In the first calculation, the payment processing unit checks whether the participants who have approved the pre-defined split payment transaction have sufficient balance against the amount they approved. Participants with insufficient funds are not included in the next step calculation. In the second calculation, balances determined to be sufficient on the participants' accounts in the previous step is added the available balance of the pre-defined split payment owner. If the amount calculated in the second is less than the purchase transaction amount, the transaction is rejected 1608. If the amount calculated in the second step is greater than or equal to the purchase transaction amount, the third calculation step is started. The third calculation step is performed only if the owner of the split payment determines the maximum amount for the remaining amount. This amount is determined in the “My maximum payment” field (3704 in FIG. 37). If this definition is not made, the third calculation step is skipped, and Split Authorization returns as successful 1608.

In the third calculation, balances determined to be sufficient on the participants' accounts in the previous step is subtracted from the purchase transaction amount. If the amount in the third calculation is greater than the amount defined in the “My maximum payment” field in FIG. 37, the transaction is rejected 1608. If the amount in the third calculation is less than or equal to the amount defined in the “My maximum payment” field (3704 in FIG. 37), a successful response is returned 1608.

In case the Split Authorization 1603 returns rejected 1608, Financial Instrument-Based Authorization 1602 is called API caller 1601 as rejected 1613.

In case the Split Authorization 1603 returns successfully 1608, Transfer Accepted Amount 1604 transfer service is called 1609. The balances determined to be sufficient on the participants' accounts are transferred to owner of the pre-defined split payment's related account by Transfer Accepted Amounts 1604. In case of successful transfers, Transfer Accepted Amount 1604 service returns a successful response 1610. If the transfers cannot be made, Transfer Accepted Amount 1604 service returns as an error 1610. If the transfers are successful, Financial Instrument-Based Authorization 1602 service calls Decrease Owner Account Amount 1605 service. Decrease Owner Account Amount 1605 service deducts the purchase transaction amount from owner of the pre-defined split payment's account. If the purchase transaction amount is deducted from owner of the pre-defined split payment's account, Decrease Owner Account Amount 1605 service returns successfully 1612, otherwise an error is returned 1612.

In the process, if there is a situation that prevents the authorization, a rejection response 1613 is returned to API caller 1601. If the authorization is completed as successful, a successful response 1613 is returned.

FIG. 17 illustrates an example sequence diagram for processing an online purchase transaction (Card Not Present) on a pre-defined split payment.

API Caller 1701 calls 1707 Financial Instrument-Based Authorization 1702 service for authorization of the online CNP (card not present) purchase transaction. Financial Instrument-Based Authorization 1702 performs financial instrument specific controls and authentications. If the financial instrument-based verifications are failed, the transaction is denied directly 1716. If the financial instrument-based verifications are successful, Financial Instrument-Based Authorization 1702 calls 1708 OTP or Mobile Approval Authorization 1703.

OTP (One Time Password) or Mobile Approval Authorization 1703 Mobile Verification (verification on a mobile application) verification, performs the following controls: Determines whether the transaction is marked as split payment in the OTP or Mobile Verification process. If the One Time Password (OTP) or Mobile Verification are failed, the request is denied 1709 otherwise OTP or Mobile Approval Authorization 1703 detects whether the transaction has been marked as a split payment in the One Time Password (OTP) or Mobile Verification phase. If the transaction is not marked as a split payment in the OTP or Mobile Verification process. The transaction proceeds with the regular authorization process. The regular authorization process is out of the scope.

If the transaction is marked as a split payment in the OTP or Mobile Verification phase by the user, OTP or Mobile Approval Authorization 1703 responses as successful with additional split payment information 1709.

Financial Instrument-Based Authorization 1702 calls 1710 for provision. Split Authorization 1704 performs the following controls: determines whether the pre-defined split payment is active, and checks if there is any restriction that prevents the transaction.

If any of these checks fail, a rejection response is sent 1711. If these two checks are successful, the calculation step is initialized.

In the first calculation, the payment processing unit checks whether the participants who have approved the pre-defined split payment transaction have sufficient balance against the amount they approved. Participants with insufficient funds are not included in the next step calculation. In the second calculation, balances determined to be sufficient on the participants' accounts in the previous step is added the available balance of the pre-defined split payment owner. If the amount calculated in the second is less than the purchase transaction amount, the transaction is rejected 1711. If the amount calculated in the second step is greater than or equal to the purchase transaction amount, the third calculation step is started. The third calculation step is performed only if the owner of the split payment determines the maximum amount for the remaining amount. This amount is determined in the “My maximum payment” field (3704 in FIG. 37). If this definition is not made, the third calculation step is skipped, and Split Authorization returns as successful 1711.

In the third calculation, balances determined to be sufficient on the participants' accounts in the previous step is subtracted from the purchase transaction amount. If the amount in the third calculation is greater than the amount defined in the “My maximum payment” field in FIG. 37, the transaction is rejected 1711. If the amount in the third calculation is less than or equal to the amount defined in the “My maximum payment” field (3704 in FIG. 37), a successful response is returned 1711.

In case the Split Authorization 1704 returns rejected 1711, Financial Instrument-Based Authorization 1702 is called API caller 1701 as rejected 1716.

In case the Split Authorization 1704 returns successfully 1711, Transfer Accepted Amount 1705 transfer service is called 1712. The balances determined to be sufficient on the participants' accounts are transferred to owner of the pre-defined split payment's related account by Transfer Accepted Amounts 1705. In case of successful transfers, Transfer Accepted Amount 1705 service returns a successful response 1713. If the transfers cannot be made, Transfer Accepted Amount 1705 service returns as an error 1713. If the transfers are successful, Financial Instrument-Based Authorization 1702 service calls Decrease Owner Account Amount 1706 service. Decrease Owner Account Amount 1706 service deducts the purchase transaction amount from owner of the pre-defined split payment's account. If the purchase transaction amount is deducted from owner of the pre-defined split payment's account, Decrease Owner Account Amount 1706 service returns successfully 1715, otherwise an error is returned 1715.

In the process, if there is a situation that prevents the authorization, a rejection response 1716 is returned to API caller 1701. If the authorization is completed as successful, a successful response 1716 is returned.

FIG. 18 illustrates an example flowchart for processing a predefined split payment creation request on application server.

At block 1801, a predefined split payment definition request sent from the user device is received by the payment processing unit. The payment processing unit checks whether the users identified in the request are eligible to be a participant at block 1802. Although not limited to these controls, eligibility controls include checks such as whether a customer is registered, customer status, and limits. If the eligibility controls are not successful, the request is rejected at block 1810. If the eligibility controls are successful, the payment processing unit checks whether the main amount defined for the predefined split payment is greater than or equal to the total amount of the participants 1803. The owner of the predefined split payment can also be a participant. Whether the owner of the predefined split payment is a participant or not is included in the definition parameters. If the amount controls are not successful, the request is rejected at block 1810. If the previous step is successful, the payment processing unit checks whether the unique/special PIN defined for the predefined split payment is different from the current card PIN 1804. If the PINs are not different, the definition is rejected 1810 because the predefined split payment process cannot be separated by the system. If all controls are successful, a pre-defined split payment record is created on the system 1805. The unique/special PIN defined on the created pre-defined split payment record is stored 1806. Participants are recorded on the pre-defined split payment 1807. Defined rules and restrictions are recorded on the pre-defined split payment 1808. Within these restrictions, the purchase can be limited by parameters such as sector, sector group, specific merchant, location etc. The terms of use include, but are not limited to, expire date for the split payment, maximum amount of owner of the predefined split payment. In the predefined payment, the remaining amount, excluding the amounts that can be received from the participants, is deducted from the owner of the predefined split payment. In this case, the maximum amount that can be deducted from the owner of the predefined split payment can be defined while creating the “predefined split payment” as a limit 1808. After the registration is completed, the notifications are sent to the relevant users over the specified channels at block 1809.

FIG. 19 illustrates an example flowchart diagram for processing an amount update request of existing pre-defined split payment definition on application server.

At block 1901, an amount update request sent for a pre-defined split payment from the user device is received by the system. The system checks whether the main amount defined for the predefined split payment is greater than or equal to the total amount of the participants 1902. If the amount controls are not successful, the request is rejected at block 1905. If the previous step is successful, the amount of the predefined split payment is updated with the new amount value 1903. After the update is completed, the notifications are sent to the relevant persons over the specified channels at block 1904.

FIG. 20 illustrates an example flowchart diagram for processing PIN change request of existing pre-defined split payment definition on application server.

At block 2001, a PIN change request sent for a pre-defined split payment from the user device is received by the system. The system checks whether the unique/special PIN defined for the pre-defined split payment is different from the current card PIN at block 2002. If the PINs are not different, the definition is rejected 2004 because the pre-defined split payment process cannot be separated by the system. If all controls are successful, the unique/special PIN is updated 2003.

FIG. 21 illustrates an example flowchart diagram for processing parameter and restriction update request of existing pre-defined split payment definition on application server.

At block 2101, a parameter and restriction update sent for a pre-defined split payment from the user device is received by the system. The parameters and restrictions are updated on the pre-defined split payment definition 2102. After the update is completed, the notifications are sent to the relevant persons over the specified channels at block 2103.

FIG. 22 illustrates an example flowchart diagram for processing delete a participant request of existing pre-defined split payment definition on application server.

At block 2201, a delete a participant sent for a pre-defined split payment from the user device is received by the system. The participant is deleted on the pre-defined split payment definition 2202. After the update is completed, the notifications are sent to the relevant persons over the specified channels at block 2203.

FIG. 23 illustrates an example flowchart diagram for processing delete a pre-defined split payment on application server.

At block 2301, a delete a pre-defined split payment request sent from the user device is received by the system. The registered pre-defined split payment is deleted 2302. If there is a blockage on any account, the blockages are removed. Even if the participants have accepted the pre-defined split payment request, they will not be affected by this deletion as money transfers are not made. After the deletion is completed, the notifications are sent to the relevant persons over the specified channels at block 2303.

FIG. 24 illustrates an example flowchart diagram for processing participant(s)′ amount update request of existing pre-defined split payment definition on application server.

At block 2401, a participant(s)′ amount update request sent for a pre-defined split payment from the user device is received by the system. The system checks whether the main amount defined for the pre-defined split payment is greater than or equal to the total amount of the participants 2402. If the amount controls are not successful, the request is rejected at block 2406. If the previous step is successful, the system checks whether the participant to be updated has approved or denied the previously submitted request 2403. If the participant to be updated has approved or denied the previously submitted request, the request is rejected 2406. As an alternative to the rejection of the update process, the participant may be asked to confirm the changed amount. If the previous control is successful, the participants' amounts are updated 2804. After the update is completed, the notifications are sent to the relevant persons over the specified channels at block 2405.

FIG. 25 illustrates an example flowchart diagram for processing a participant response of existing pre-defined split payment request on application server.

At block 2501, a participant response sent for a pre-defined split payment from the participant device is received by the system. The system detects whether the answer is rejected or accepted at block 2502. If the response is an acceptance, the system checks whether the participant status can approve at block 2503. The purpose of the status check is to prevent errors in processing approvals or rejections from different sources in the system. For example, a participant can reject the request from the browser. After processing the rejection response, the participant can try approving the same request from the mobile application. In addition, during this verification process, the participant may have been deleted from the pre-defined split payment or a different reason may have occurred that would prevent the participation. (e.g., fraud status change). If the participant's status is not suitable for approval, the request is rejected at block 2507. If the participant status check is successful, the system checks whether the pre-defined split payment is active or not at block 2504. If the corresponding pre-defined split payment is not active, the request is denied at block 2507. If the relevant pre-defined split payment status is active, the participant status is updated as approved at block 2505. After the update is completed, the notifications are sent to the relevant users over the specified channels at block 2506. If the participant rejects the pre-defined split payment request, the participant status is checked at block 2508. If the participant's status is not suitable for approval, the request is rejected at block 2507. If the participant status check is successful, the participant status is updated as rejected at block 2509. After the update is completed, the notifications are sent to the relevant persons over the specified channels at block 2510.

FIG. 26 illustrates an example flowchart diagram about authorization process for a purchase transaction CP (Card Present) linked to pre-defined split payment on application server.

At block 2601, the purchase transaction is received by the system. The system performs verification checks specific to the financial instrument at block 2602. At block 2603, Payment instrument-based authorization result is checked. If the financial instrument-based verification checks fail, the transaction is rejected at block 2613. At block 2604, the system checks whether the PIN has been defined for a pre-defined split payment. In case the PIN is not defined for a pre-defined split payment transaction, the transaction proceeds with the regular authorization process 2614. If the PIN is defined for a pre-defined split payment, the system checks whether the defined pre-defined split payment definition is active 2605. If the pre-defined split payment is not active, the authorization is denied at block 2615. If the relevant pre-defined split payment is active, it is checked whether there is any restriction or rules that prevents performing the transaction at block 2606. if there is a rule or restriction preventing the transaction from being performed, the authorization is denied at block 2615. If the restriction and rules checks are successfully completed, the system checks whether the participants who have approved the pre-defined split payment transaction have sufficient balance against the amount they approved 2607. Participants with insufficient funds are not included in the next step calculation.

The system calculates the total amount of the approved participants who had sufficient balance in the previous step+the available balance of the split payment owner's account. (Calculated Amount) 2608. When the checked total amount that can be collected from the participants is subtracted from the purchase transaction amount, if it exceeds the maximum amount defined by the owner of the pre-defined split payment, the transaction is rejected 2615. If the transaction is not rejected at block 2609, it is checked whether the Calculated Amount at block 2608 is greater than or equal to the transaction amount 2610. If the greater or equal condition cannot be provided, the transaction is rejected 2615. If the greater or equal condition can be provided, the amounts with sufficient balance checks in block 2607 are transferred from the participants to the split payment owner's account. After the transfers are performed, the purchase transaction amount is deducted from the split payment owner account 2611. The system returns a transaction response as successful 2612.

FIG. 27 illustrates an example flowchart diagram about authorization process for an online purchase transaction CNP (card not present) linked to pre-defined split payment on application server.

At block 2701, the purchase transaction is received by the system. The system performs verification checks specific to the financial instrument at block 2702. At block 2703, Payment instrument-based authorization result and one-time password (OTP) or mobile (mobile application based) verification is checked. If the previous controls at block 2702 is fail, the transaction is rejected at block 2713. If the previous controls at block 2702 is successful, the system checks whether the transaction has been marked for a pre-defined split payment in OTP or Mobile Verification process at block 2604. In case the transaction is not marked as a split payment transaction, the transaction proceeds with the regular authorization process 2714. If the transaction is marked as a split payment, the system checks whether the defined pre-defined split payment definition is active 2705.

If the pre-defined split payment is not active, the authorization is denied at block 2715.

If the relevant pre-defined split payment is active, it is checked whether there is any restriction or rules that prevents performing the transaction at block 2706. if there is a rule or restriction preventing the transaction from being performed, the authorization is denied at block 2715. If the restriction and rules checks are successfully completed, the system checks whether the participants who have approved the pre-defined split payment transaction have sufficient balance against the amount they approved 2707. Participants with insufficient funds are not included in the next step calculation.

The system calculates the total amount of the approved participants who had sufficient balance in the previous step+the available balance of the split payment owner's account. (Calculated Amount) 2708. When the checked total amount that can be collected from the participants is subtracted from the purchase transaction amount, if it exceeds the maximum amount defined by the owner of the pre-defined split payment, the transaction is rejected 2715. If the transaction is not rejected at block 2709, it is checked whether the Calculated Amount at block 2708 is greater than or equal to the transaction amount 2710. If the greater or equal condition cannot be provided, the transaction is rejected 2715. If the greater or equal condition can be provided, the amounts with sufficient balance checks in block 2707 are transferred from the participants to the split payment owner's account. After the transfers are performed, the purchase transaction amount is deducted from the split payment owner account 2711. The system returns a transaction response as successful 2712.

The PIN abbreviation mentioned in the document represents the Personal Identification Number used by open loop or closed loop card payments to verify the cardholder. The PIN used in standard card payments is usually numeric and 4 or 6 digits.

The invention works with online PIN verification. For this reason, PINs are stored and verified on the application server, not on the user device. PINs are stored by using HSM devices and in accordance with PCI DSS (Payment Card Industry-Data Security Standards).

In a card payment process, it may be necessary to make changes on the card, terminal, acquirer to determine whether the transaction is a split payment transaction. In addition, the payment network will need to adapt or allow this change.

The invention allows the cardholder to determine that the transaction is a split payment transaction without making any changes to the card, terminal, acquirer or payment network in a standard card payment process that works with online PIN verification.

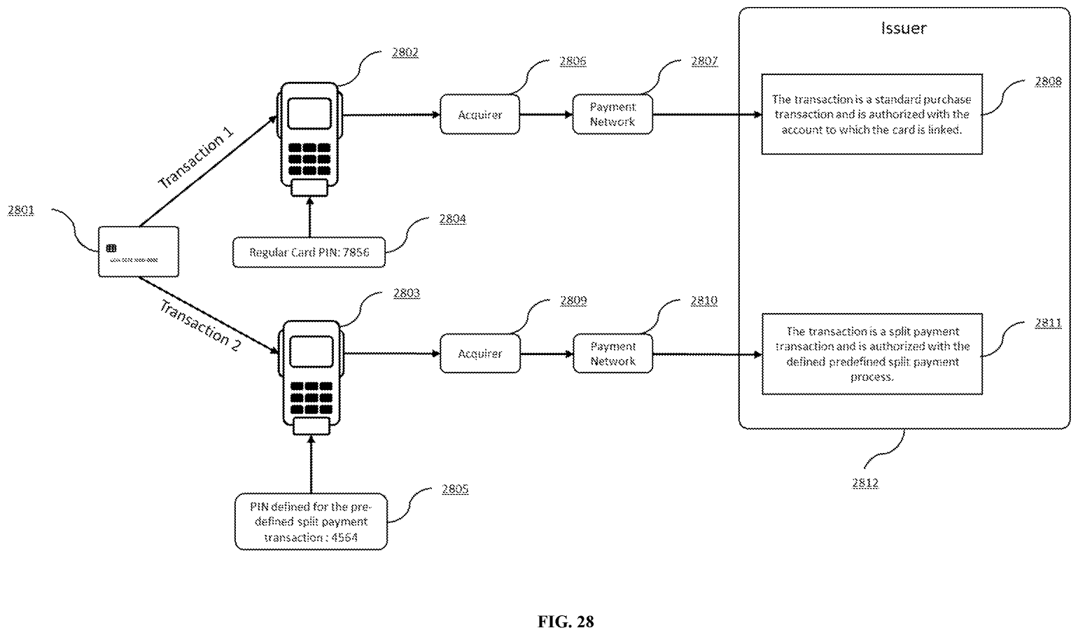

FIG. 28 describes how the transaction is separated as a split payment on the application server with unique/special PIN entrance on the terminal.

This example is described in the standard flow in an open loop card process. The transaction is transmitted from the terminal 2802, 2803 to the acquirer 2806, 2809 then from the acquirer to the payment network 2807, 2810 and through the payment network to the issuer 2812. The issuer 2812 represents the institution issuing the card for its customers and the main system in which the invention works.

### Transaction 1

In this example, the current password of the card 2801 is set to “regular card PIN: 7856” 2804. A purchase transaction made by entering the “regular card PIN: 7856” 2804 will be processed as a standard purchase transaction over the account balance to which the card is linked 2808.

### Transaction 2

In case the cardholder enters the “unique/special PIN: 4564” 2805 defined in the pre-defined split payment creation process for the purchasing transaction, the invention detects that the transaction is a pre-defined split payment transaction because the unique/special PIN is used and authorizes the transaction through the predefined split payment process 2811.

In this example, the card 2801 is not changed. Likewise, the terminal 2802, 2803, acquirer 2806, 2809 and payment network 2807, 2810 do not change. The invention card, terminal, acquirer and payment network independently detect the difference between the split payment and the regular payment only by changing the PIN entered during the transaction.

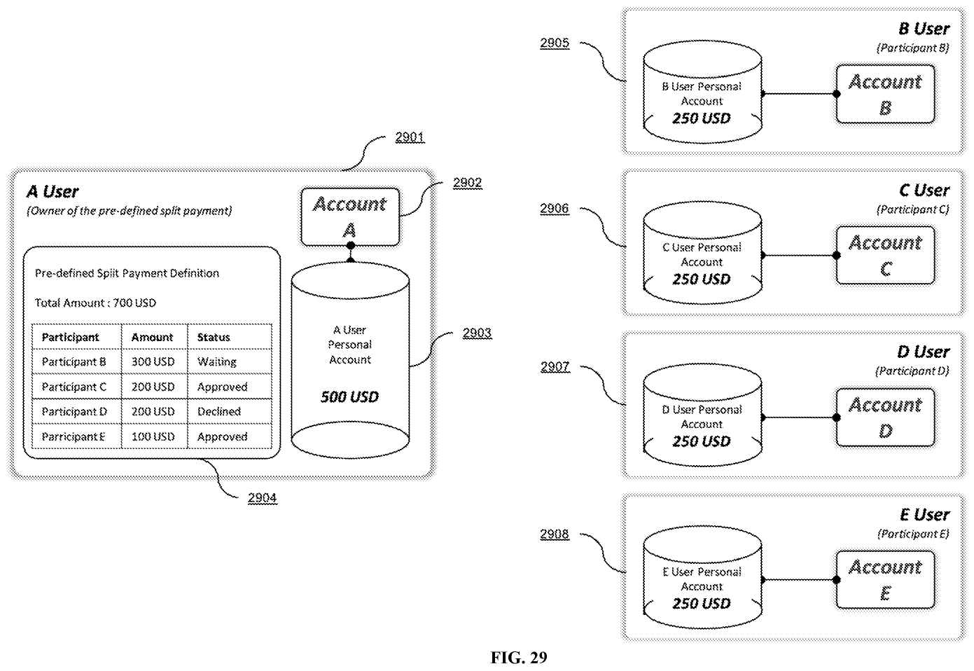

In FIGS. 29, 30 and 31, changes in the accounts of participants and owner of the pre-defined split payment before, during and after a purchase transaction are illustrated through an example. In a pre-defined split payment definition, participants can have the following 3 types of statuses.
Waiting: The pre-defined split payment request was sent to the participant, but the participant did not respond to the request.
Denied: The participant responded to the pre-defined split payment request as rejection.
Approved: The participant approved the pre-defined split payment request as acceptance.

FIG. 29 illustrates the account and balance status of participants and owner of the pre-defined split payment before a purchase transaction.

A User has defined a $700 pre-defined split payment 2904 in which users B User, C User, D User and E User are participants. At this stage, the responses of the participants to the pre-defined split payment request are as follows:
Participant B did not respond to a joint payment request of 300 USD. (Waiting)
Participant C accepted the 200 USD joint payment request. (Accepted)
Participant D rejected the 200 USD joint payment request. (Declined)
Participant E accepted the 100 USD joint payment request. (Accepted)

At this stage, the balances of the users are as follows:
A User Balance: 500 USD in A User Personal Account 2903
B User Balance: 250 USD in B User Personal Account 2905
C User Balance: 250 USD in C User Personal Account 2906
D User Balance: 250 USD in D User Personal Account 2907
E User Balance: 250 USD in E User Personal Account 2908

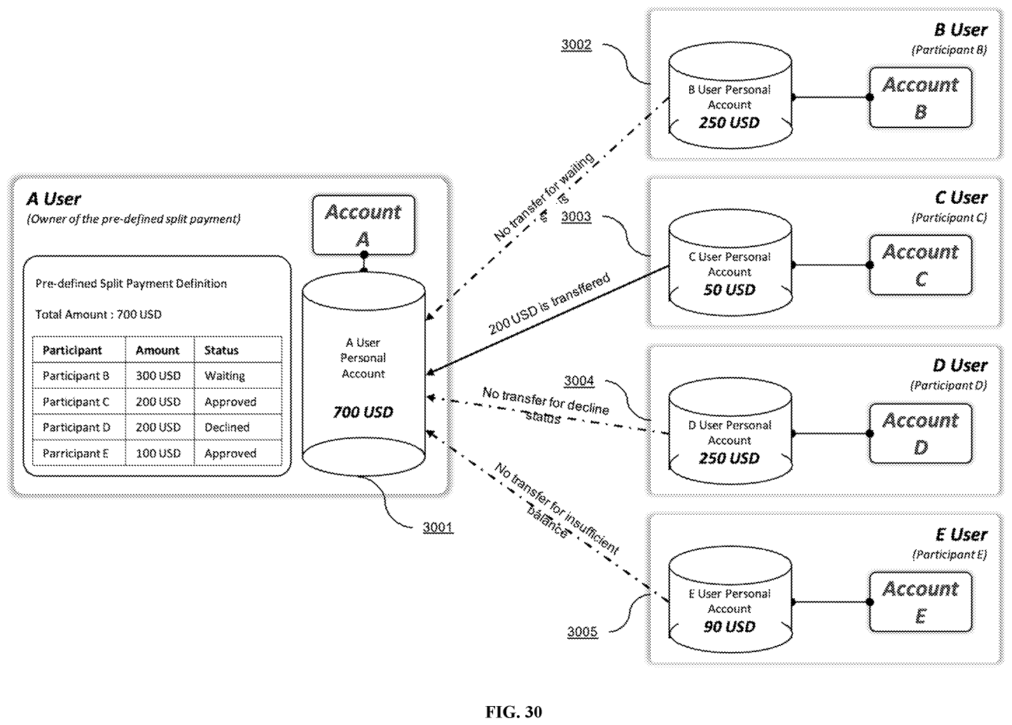

FIG. 30 illustrates the account and balance status of participants and owner of the pre-defined split payment during a purchase transaction.

At this stage, the process of transferring the accepted amounts from the participants to the owner of the pre-defined split payment's account is explained. These transfer transactions are made during the purchase transaction. One of the most important elements that distinguishes the invention from other split payment structures is that the transfers from the participants are made at the moment of the transaction.

At this stage, the following changes and transfers are taking place in the balances:
User B is not included in the pre-defined split payment and money transfer is not made, as the user does not respond to the pre-defined split payment request 3002.
200 USD, which is accepted by User C, is transferred to user and 50 USD remains in the account of user C 3003.
Because User D refuses the pre-defined split payment request, User D is not included in the pre-defined split payment and no money transfer takes place 3004.
User E accepted the pre-defined split payment request when the balance was 250 USD, but the balance at the time of the transaction was 90 USD. User E's balance is less than 100 USD confirmed at the time of transaction. For this reason, money transfer could not be made due to insufficient balance 3005.
User A's balance increased to 700 USD after 200 USD was transferred from user C 3001.

If the incoming transaction is a $700 purchase transaction, user A has sufficient funds to make the transaction. Immediately after these transfers are made at the time of the transaction, the 700 USD purchase is deducted from balance of person A. The situation after the purchase transaction is explained in FIG. 30.

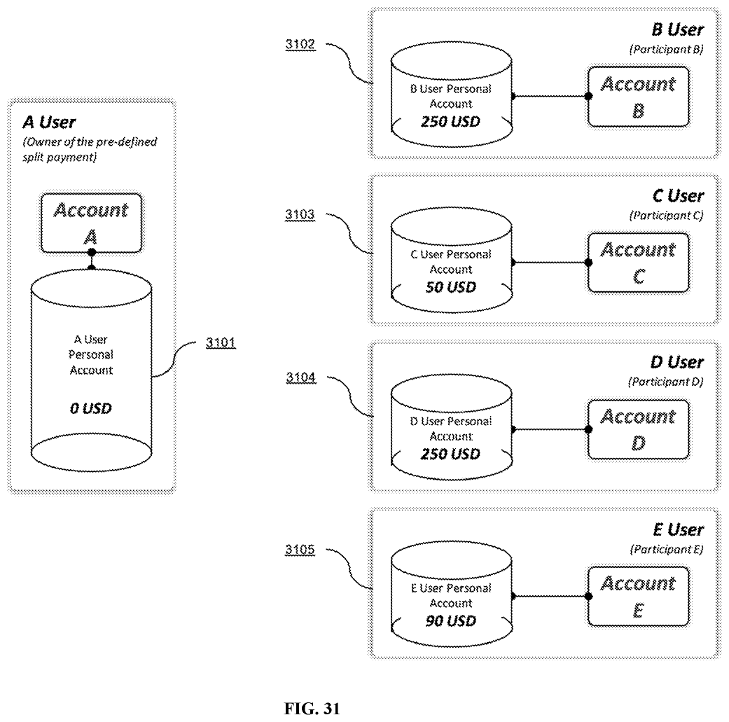

FIG. 31 illustrates the account and balance status of participants and owner of the pre-defined split payment after a purchase transaction.
The 700 USD purchase transaction was successful.
700 USD was deducted from the balance of User A and the balance of User A was 0 USD 3101.
The balance of User B has not changed since there is no money transfer from user B 3102.
200 USD was transferred from user C to user A and the balance of user C was 50 USD 3103.
The balance of User D has not changed since there is no money transfer from user D 3104.
The balance of User E has not changed since there is no money transfer from user E 3105.

The balance of user E in FIG. 29 is 250 USD, but at the time of transaction it is 90 USD in FIG. 30. The reason for this decrease is that user E spends 160 USD for personal spending in the time between FIG. 29 and FIG. 30.

The example described in FIGS. 29, 30 and 31 has been prepared to better be understanding the operation of the invention. The statuses or logics can change or be removed according to business requirements. For example: The participant can accept a 100 USD pre-defined split payment request for 80 USD. In this case, participant status can be given as partial approval.

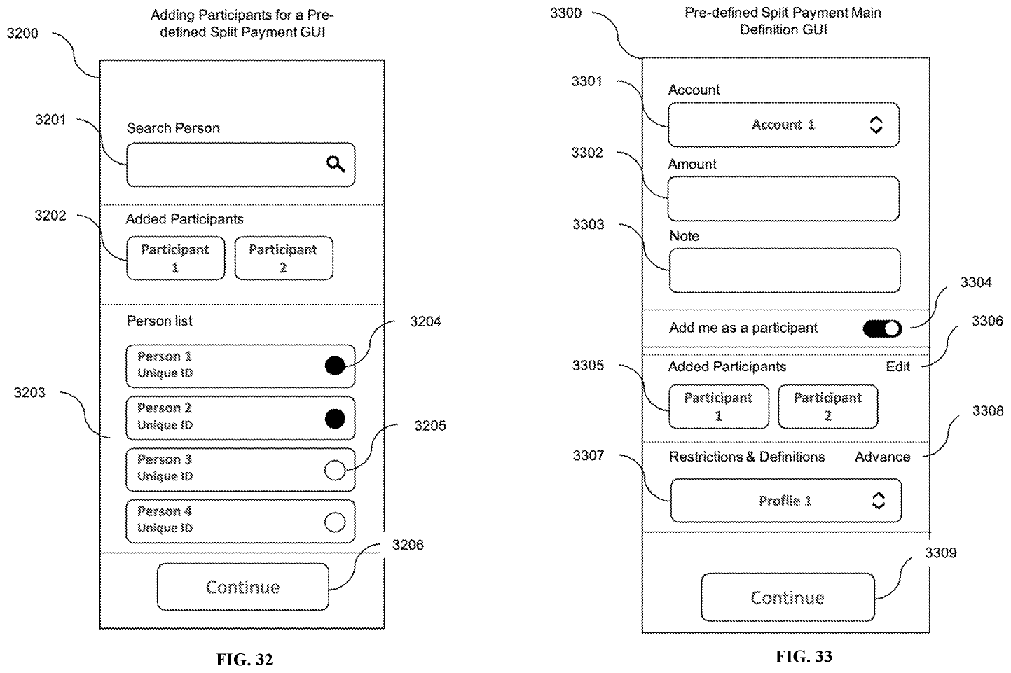

FIG. 32 illustrates an example graphical user interface (GUI) for adding participant for a pre-defined split payment.

This GUI is an example screen where participant additions are made, which is opened at the first stage of a pre-defined split payment.

This screen 3200 allows the user to add participants to pre-defined split payment by selecting from their contact list. Participants can be searched with a name, a phone number or a unique ID written in the user text box 3201. The added participants are listed in 3202 area. The contact list 3202 can be scrolled up or down. The person can be added to the account sharing by clicking on the field 3205 next to the person. The filled circle in the 3204 field indicates whether the contact has been added. the user presses the continue button 3206 to complete the participant selection.

FIG. 33 illustrates an example graphical user interface (GUI) for defining general parameters of a pre-defined split payment.

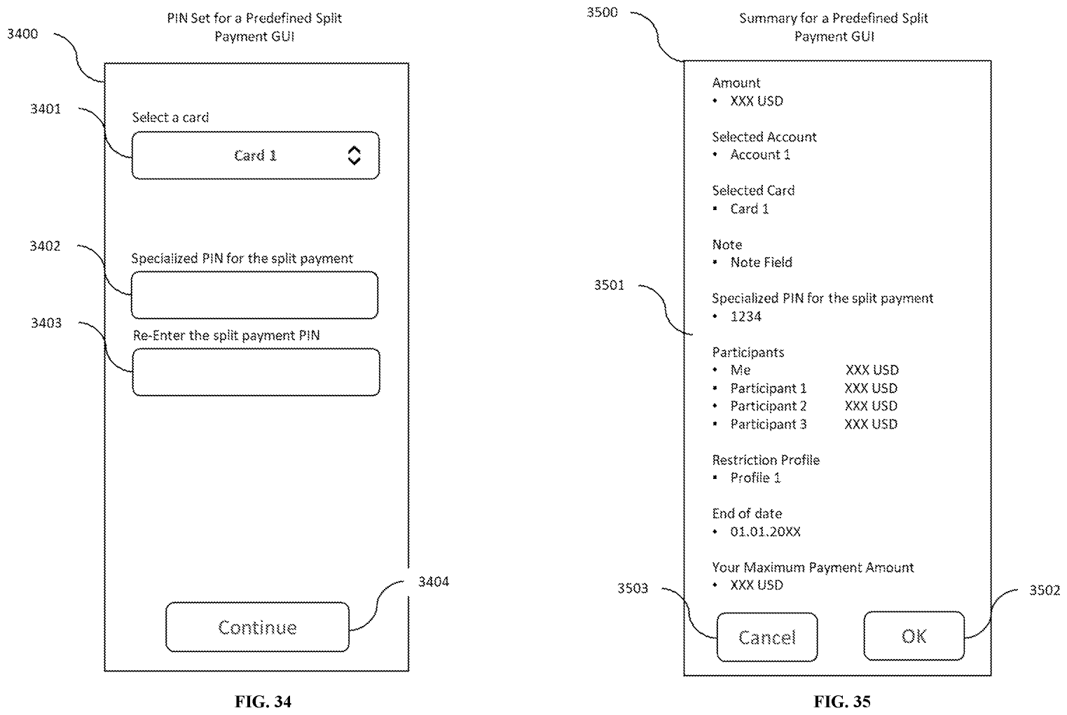

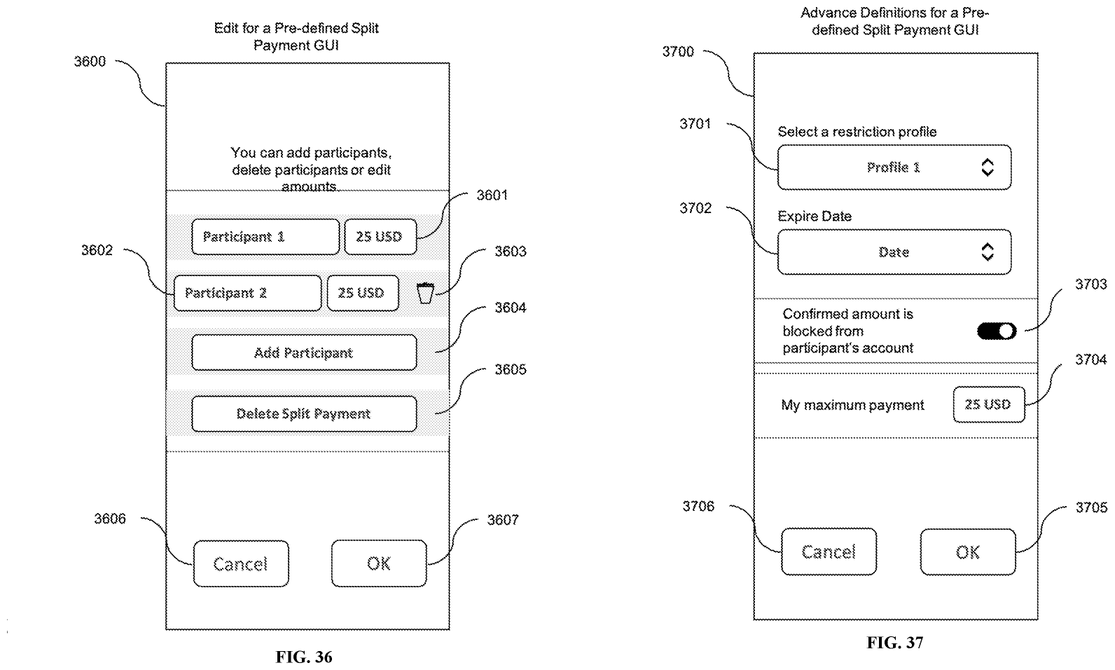

This screen 3300 allows the user to define general parameters of a pre-defined split payment. The box 3301 indicates selected account to be used for the pre-defined split payment. The amounts to be collected from the participants will be transferred to this account and authorization will be given over this account. In addition, the remaining amount after deducting the amounts received from the participants from the purchase transaction amount will be taken from the available balance in this account. 3301 is a drop-down list for listing existing account of the user. The user can select a different account from the drop-down account list. Pre-defined split payment amount is determined by writing in 3302 field. The amount determined cannot be less than the purchase transaction amount to be performed, but it can be equal or more. With the information entered in the note field 3303, participants can be informed about the pre-defined split payment. This note will appear in the confirmation notifications sent to the participants. When this option is checked as a toggle button 3304, the person who created the pre-defined split payment is included in the definition as a participant and the transaction amount is divided among these participants. The added participants are listed in 3305 area. By clicking on the Edit button 3306, the screen shown in FIG. 36 can be opened, and operations such as determining the amount per participant, adding participant, removing participant can be done. The user can define restrictions by choosing from the preset profiles 3307. User does not have to choose a restriction profile. This field can be passed without defining it as none. Pre-defined profiles can be made according to the project requirements, for example, profiles such as food, fuel, gift profiles can be settled. When the food profile is selected, the purchase transaction can be declined when it is received through a merchant without a food merchant category code definition. By clicking on the Advance button 3308, the screen shown in FIG. 37 can be opened, and operations such as “confirmed amount is blocked from participant's account”, “my maximum payment”, “expire date” can be defined as advance parameters. By clicking on the continue button 3309, the definition process continues with the unique/special PIN definition process in FIG. 34.

FIG. 34 illustrates an example graphical user interface (GUI) PIN Set of a pre-defined split payment.

This screen 3400 allows to set a unique/special PIN to the selected financial instrument (in this example it is defined as card) for the pre-defined split payment transaction.

In “Select Card” field 3401, the card to be used in the purchase transaction is selected. This is a drop-down list and the user's cards are listed here 3401. The user can choose any of the listed cards. The PIN definition step is necessary only for physical cards. There is no PIN definition for virtual cards to be used in CNP (Card Not Present) transactions. For virtual cards, card selection is made only.

Even without selecting a financial instrument, only the PIN is determined, and the pre-defined split payment infrastructure can be operated. In “without selecting a financial instrument” case, a pre-defined split payment flow can be initiated by determining the unique/special PIN receiving from any purchase transaction. In this case, the unique/special PIN must be different from all PINs of the user's current cards.

In “Specialized PIN for the split payment” field 3402, the PIN to be determined specifically for the purchase transaction is entered. The unique/special PIN must be different from the current PIN of the selected card. Otherwise, the payment processing unit cannot detect that the purchase transaction is a pre-defined split payment transaction. For this reason, the same unique/special PIN definition with the current card PIN is not allowed.

In order to prevent the wrong PIN conditions, the user is requested to re-enter the PIN in the field 3403.

By clicking on the continue button 3404, the definition process continues with opening the summary screen in FIG. 35.

FIG. 35 illustrates an example graphical user interface (GUI) Summary of a pre-defined split payment.

On this screen 3500, a summary of the information 3501 defined to the user is shown. When the user wants to change a parameter in the summary screen, the user can open the “defining general parameters” screen in FIG. 33 by clicking the cancel button 3503 and make the desired change. The user can click the OK button 3502 to complete the definition process.

FIG. 36 illustrates an example graphical user interface (GUI) Edit of a pre-defined split payment.

This screen 3600 is where the user can add participant, delete participant, determine amount for each participant and delete pre-defined split payment.

Participant's amount can be changed on the box 3601. The user swipes left 3602 on the participant and deletes the participant with the appeared delete button 3603. 3604 is the button for adding new participants. When 3604 button is pressed, the participant add screen in FIG. 32 opens. Pre-defined split payment can be deleted by pressing the 3605 button.

The changes can be confirmed by clicking the OK button 3607. Click the Cancel button 3606 to return to the previous screen without making any changes.

FIG. 37 illustrates an example graphical user interface (GUI) Advance Definitions of a pre-defined split payment.

On this screen 3700, the restriction profiles can be changed, an expire date can be determined for the pre-defined split payment, the amounts approved by the participants can be blocked, and the maximum amount that can be deducted from the owner of the pre-defined split payment can be defined. The user can define restrictions by choosing from the preset profiles 3701. Restriction profile field 3701 can be passed without defining it as none. The pre-defined split payment definition will be invalid after the date selected in “expire date” field 3702. “Expire date” field 3702 can be passed without defining it as none.

When this field is selected with the Toggle button 3703, the amounts in the pre-defined split payment request approved by the participants are blocked from the participant accounts until the transaction is made or until the “Expire date”. If this option is selected, participants will not be able to use these amounts in their accounts. In this way, the possibility that the accepted amounts cannot be transferred from the participants at the time of the transaction is prevented.

The owner of pre-defined split payment pays the remaining amount of the transaction, excluding the amounts that can be collected from the participants. “My maximum amount” definition 3704 is used to cover the remaining amount up to a certain limit. If the remaining amount is above this definition, the purchase transaction is not allowed.

The changes can be confirmed by clicking the OK button 3705. Click the Cancel button 3706 to return to the previous screen without making any changes.

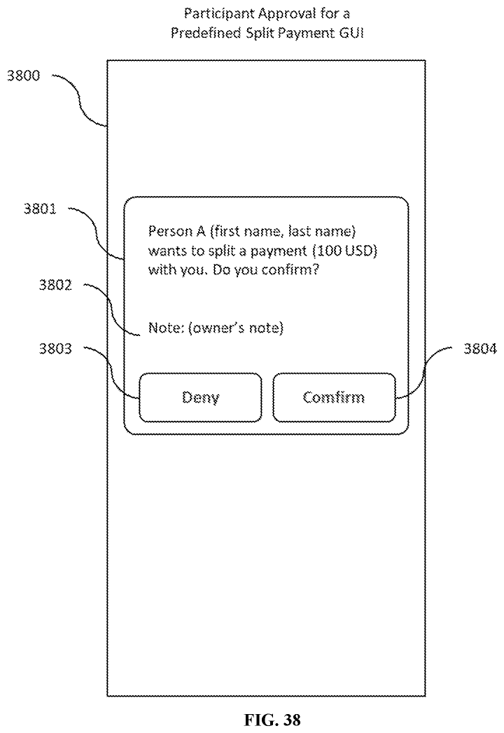

FIG. 38 illustrates an example graphical user interface (GUI) for participant approval of pre-defined split payment request.

This screen 3800 is the notification screen where a participant added to a pre-defined split payment approves or declines the split payment request.

This screen 3800 allows the participant to approve or deny the pre-defined split payment request received with a notification. Block 3801 is the notification box. More information can be included in this information box. 3802 is owner of the pre-defined split payment note. If 3803 button is pressed, the request is rejected by the participant. If 3804 button is pressed, the request is accepted.

The payment processing unit can detect that the transaction is a pre-defined split payment transaction with the unique/special PIN entry in card present (CP) payments and authorize the transaction through this pre-defined split payment definition.

However, there is no PIN entry in Card Not Present (CNP) transactions. For this reason, a different definition is required to define that the transaction is a split payment transaction. The definition can be done in mobile or One Time Password (OTP) verification steps in CNP transactions. The following screens

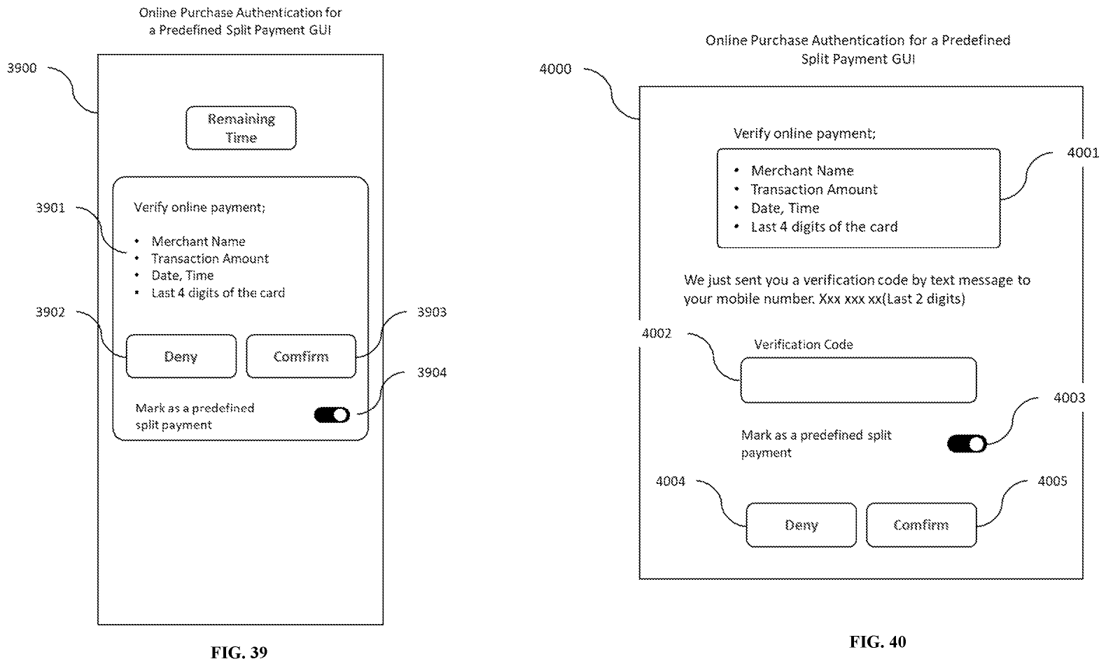

FIG. 39 illustrates an example graphical user interface (GUI) for marking a card not present (CNP) transaction as a split payment during a mobile verification step.

The screen 3900 allows to mark a Card Not Present transaction as a pre-defined split payment transaction in a mobile verification step.

Summary information about the expenditure transaction is given in this field 3901. If 3902 button is pressed, the transaction is rejected. If 3903 button is pressed, the transaction is verified by card holder. After checking this option with the toggle button 3904, if the transaction is confirmed, the transaction is marked as a split payment transaction. If this option 3904 is not checked, it will be authorized as a regular card transaction.

FIG. 40 illustrates an example graphical user interface (GUI) for marking a card not present (CNP) transaction as a split payment during a One Time Password (OTP) verification phase. The screen 4000 allows to mark a Card Not Present transaction as a pre-defined split payment transaction in a One Time Password (OTP) verification step.

Summary information about the expenditure transaction is given in this field 4001. One Time Password (OTP) is entered in the “verification code” 4002 area. If 4004 button is pressed, the transaction is rejected. If 4005 button is pressed, the transaction is verified by card holder. After checking this option with the toggle button 4003, if the transaction is confirmed, the transaction is marked as a split payment transaction. If this option 4003 is not checked, it will be authorized as a regular card transaction.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It will also be understood that, although the terms first, second, etc. are, in some instances, used herein to describe various elements, these elements should not be limited by these terms. These terms are only used to distinguish one element from another. For example, a first device could be termed a second device, and, similarly, a second device could be termed a first device, without departing from the scope of the various described embodiments. The first device and the second device are both devices, but they are not the same device, unless the context clearly indicates otherwise.

The terminology used in the description of the various described embodiments herein is for the purpose of describing particular embodiments only and is not intended to be limiting. As used in the description of the various described embodiments and the appended claims, the singular forms “a”, “an”, and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including”, “comprises”, and/or “comprising”, when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

It should be appreciated that in the development of any actual embodiment (as in any development project), numerous decisions must be made to achieve the developers' specific goals (e.g., compliance with system and business-related constraints), and that these goals will vary from one embodiment to another. It will also be appreciated that such development efforts might be complex and time consuming but would nevertheless be a routine undertaking for those of ordinary skill in the art of image capture having the benefit of this disclosure.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

What is claimed is:

1. A method for splitting payment, comprising:
prior to a purchase transaction, defining, by a user device, a split payment definition, wherein the split payment definition comprises: a unique password or personal identification number (PIN), one or more participants and an amount to be charged associated with each of the one or more participants;
transmitting, by the user device, the split payment definition to a payment processing unit (PPU);
determining that a given password or PIN for the purchase transaction matches the unique password or PIN assigned to the split payment definition;
in performing the purchase transaction, determining, by the PPU, whether the split payment definition will be used when the unique password or PIN is used, and
during performing the purchase transaction using the split payment definition, deducting, by the PPU, the amount to be charged associated with each of the one or more participants from an account associated with each of the one or more participants.

2. The method of claim 1, wherein the in performing the purchase transaction, determining, by the PPU, whether the split payment definition will be used, further comprises: whether the transaction is marked as split payment in a card not present transaction.

3. The method of claim 1, further comprising:
adding at least one of: a note, a category of purchase transaction, a date, a time, a merchant, a merchant category, a location, and a restriction on the one or more participant to share the amount to be charged associated with each participant.

4. The method of claim 1, wherein determining a split payment definition comprises at least one of:
selecting the one or more participants from a contact list directory; and
selecting the one or more participants by entering a unique identifier associated with each of the one or more participants, wherein the unique identifier is at least one of: a phone number, an account number, and a participant's email address.

5. The method of claim 1, further comprising:
upon receiving the split payment definition by the PPU,
storing the split payment definition and an identity of the user device;
sending a notification to each of the one or more participants indicating the split payment definition;
assigning to each of the one or more participants a status as waiting;
upon receiving a deny notification from a participant, removing the participant from the split payment definition and updating the status of the participant to denying participant and notifying the user about the deny notification and identity of the denying participant;
upon receiving an approve notification from a participant, updating the status of the participant to approving participant and notifying the user device about the approve notification and identity of the approving participant, and
updating the split payment definition based on the status of each of the one or more participants.

6. The method of claim 5, wherein the each of the one or more participants are notified via at least one of: a text message, a push notification, an email, and a web portal.

7. The method of claim 5, further comprising:
upon the determination that the given password or PIN for the purchase transaction matches the unique password or PIN assigned to the split payment definition, transferring to a user's account, an amount to be charged from each of the approving participants;
calculating a first amount, the first amount being equal to a total amount successfully transferred from the approving participants;
calculating a second amount, the second amount being equal to a user's available balance in the user's account;
upon a determination that a sum of the first amount and the second amount is equal to or greater than a purchase transaction amount, confirming the purchase transaction, and
upon a determination that a sum of the first amount and the second amount is less than the purchase transaction amount, transferring the amount charged back to each of the approving participants.

8. The method of claim 5, further comprising:
upon the determination that the given password for the purchase transaction matches the unique PIN or password assigned to the split payment definition, checking available balance of each participant for accepted amounts;
calculating a first amount based on total checked amounts from the approving participants;
calculating a second amount based on a user's available balance in the user's account;
upon a determination that a sum of the first amount and the second amount is equal or greater that a purchase transaction amount, transferring the accepted amounts to the user's account from the approving participants' accounts, and
performing the purchase transaction.

9. A method for splitting payment, comprising:
receiving, by a payment processing unit (PPU), a split payment definition request from a user device, wherein the split payment definition request comprises one or more participants, an amount to be charged associated with each of the one or more participants, an amount of a purchase transaction, and a unique password or personal identification number (PIN) assigned to the split payment definition request;
determining that a given password or PIN for the purchase transaction matches the unique password or PIN assigned to the split payment definition;
generating, by the PPU, a split payment definition based at least in part on the split payment definition request, and
storing, by the PPU, the split payment definition, the unique password or PIN, and the one or more participants.

10. The method of claim 9, further comprising:
receiving, by the PPU, a request to update the split payment definition by replacing the amount of the purchase transaction with a second amount;
updating, by the PPU, the split payment definition by replacing the amount of the purchase transaction with the second amount.

11. The method of claim 9, further comprising:
receiving, by the PPU, a request to update the split payment definition by replacing the unique password or PIN with a second password or PIN, and
upon a determination that the second PIN is different from a card PIN, updating, by the PPU, the split payment definition by replacing the unique password or PIN with the second PIN.

12. The method of claim 9, further comprising:
receiving, by the PPU, a request to add a first one or more additional parameters to the purchase transaction, wherein the first one or more additional parameters comprises at least one of: a note, a category of purchase transaction, a date, a time, a merchant, a merchant category, a location, an expiration date for the split payment definition, and a restriction to share the amount of the one or more participants is charged, from the user device, and
updating, by the PPU, the split payment definition based on the first one or more additional parameters.

13. The method of claim 12, further comprising:
receiving, by the PPU, a request to update the split payment definition by replacing the first one or more additional parameters with a second one or more additional parameters, and
updating, by the PPU, the split payment definition by replacing the first one or more additional parameters with the second one or more additional parameters.

14. The method of claim 9, further comprising:
receiving, by the PPU, a request to update the split payment definition by deleting a participant from the one or more participants, and
updating, by the PPU, the split payment definition by deleting a participant from the one or more participants.

15. The method of claim 9, further comprising:
receiving, by the PPU, a request to update the split payment definition by deleting a split payment definition, and
updating, by the PPU, the split payment definition by deleting the split payment definition.

16. The method of claim 9, further comprising:
receiving, by the PPU, a request to update the split payment definition by changing an amount to be charged associated with a participant of the one or more participants, and
updating, by the PPU, the split payment definition by changing the amount to be charged associated with one of the one or more participants.

17. The method of claim 9, further comprising:
receiving, by the PPU, a response from a participant of the one or more of the participants, the response being indicative of whether the participant accepted or rejected the amount to be charged associated with the participant;
upon a determination that the response is an acceptance, determining, by the PPU, whether the participant is allowed to approve, and
upon a determination that the split payment definition is active, updating, by the PPU, a status of the participant to approving.

18. The method of claim 9, further comprising:
receiving, by the PPU, a purchase transaction;
performing, by the PPU, a verification check specific to a financial instrument associated with the purchase transaction;
determining, by the PPU, whether the financial instrument is authorized to participate in the purchase transaction;
upon the determination that the unique password or PIN is defined for the split payment definition, determining, by the PPU, whether the split payment definition is active;
upon a determination that the split payment definition is active, determining, by the PPU, whether there are any restrictions or rules that prevent performing the purchase transaction;
determining, by the PPU, whether each approving participant has sufficient funds to pay the amount to be charged associated with the participant for approved amounts;
calculating a first amount based on total checked amounts from the approving participants;
calculating a second amount based on a user's available balance in the user's account;
upon determinations that the sum of first and second amount is equal to or greater than the amount of the purchase transaction, transferring, by the PPU, the amounts to be charged associated with the approving participants to the user's account, and
deducting, by the PPU, the amount of purchase transaction from the user's account.

19. The method of claim 18, further comprising: upon a determination that the special password or PIN is not defined for the split payment definition, performing, by the PPU, the purchase transaction via a regular authorization process.

20. The method of claim 2, further comprising:
receiving, by the PPU, a purchase transaction;
performing, by the PPU, a verification-check specific to a financial instrument associated with the purchase transaction;
determining, by the PPU, whether the financial instrument is authorized to participate in the purchase transaction;
upon a determination that the purchase transaction has been marked for a split payment definition in a one-time password or a mobile application-based verification process, determining, by the PPU, whether the split payment definition is active;
upon a determination that the split payment definition is active, determining, by the PPU, whether there are any restrictions or rules that prevent performing purchase transaction;
determining, by the PPU, whether each approving participant has sufficient funds to pay the amount to be charged associated with the participant for approved amounts;
calculating a first amount based on total checked amounts from the approving participants;
calculating a second amount based on a user's available balance in the user's account;
upon determinations that the sum of first and second amount is equal to or greater than the amount of the purchase transaction, transferring, by the PPU, the amounts to be charged associated with the approving participants to the user's account, and
deducting, by the PPU, the amount of purchase transaction from the user's account.

21. The method of claim 2, further comprising:
adding at least one of: a note, a category of purchase transaction, a date, a time, a merchant, a merchant category, a location, and a restriction on the one or more participant to share the amount to be charged associated with each participant.

22. The method of claim 2, wherein determining a split payment definition comprises at least one of:
selecting the one or more participants from a contact list directory; and
selecting the one or more participants by entering a unique identifier associated with each of the one or more participants, wherein the unique identifier is at least one of: a phone number, an account number, and a participant's email address.

23. The method of claim 2, further comprising:
upon receiving the split payment definition by the PPU,
storing the split payment definition and an identity of the user device;
sending a notification to each of the one or more participants indicating the split payment definition;
assigning to each of the one or more participants a status as waiting;
upon receiving a deny notification from a participant, removing the participant from the split payment definition and updating the status of the participant to denying participant and notifying the user about the deny notification and identity of the denying participant;
upon receiving an approve notification from a participant, updating the status of the participant to approving participant and notifying the user device about the approve notification and identity of the approving participant, and
updating the split payment definition based on the status of each of the one or more participants.

24. The method of claim 6, further comprising:
upon the determination that the given password or PIN for the purchase transaction matches the unique password or PIN assigned to the split payment definition, transferring to a user's account, an amount to be charged from each of the approving participants;
calculating a first amount, the first amount being equal to a total amount successfully transferred from the approving participants;
calculating a second amount, the second amount being equal to a user's available balance in the user's account;
upon a determination that a sum of the first amount and the second amount is equal to or greater than a purchase transaction amount, confirming the purchase transaction, and
upon a determination that a sum of the first amount and the second amount is less than the purchase transaction amount, transferring the amount charged back to each of the approving participants.

25. The method of claim 18, further comprising:
calculating, by the PPU, a remaining amount to the owner of the split payment and determining whether the remaining amount exceeds a user's predefined maximum participation amount,
wherein the remaining amount does not exceed the user's predefined maximum participation amount for the transaction to be accepted.

26. The method of claim 19, further comprising:
calculating, by the PPU, a remaining amount to the owner of the split payment and determining whether the remaining amount exceeds a user's predefined maximum participation amount,
wherein the remaining amount does not exceed the user's predefined maximum participation amount for the transaction to be accepted.

27. A method for splitting payment, comprising:
prior to a payment transaction, defining, by a user device, a split payment definition, wherein the split payment definition comprises: a unique password or unique personal identification number (PIN), one or more participants and a portion to be charged associated with each of the one or more participants;
transmitting, by the user device, the split payment definition to a payment processing unit (PPU);
receiving, by a payment terminal, the payment transaction comprising a payment instrument associated with the split payment definition, a payment password or payment PIN, and a payment amount;
the PPU receiving, by a payment network, the payment transaction comprising the payment instrument, the payment password or payment PIN, and the payment amount;
determining, by the PPU, that the payment password or payment PIN for the payment transaction matches the unique password or unique PIN assigned to the split payment definition associated with the payment instrument;
in processing the payment transaction, determining, by the PPU, whether the split payment definition will be used when the unique password or unique PIN is received,
when performing the payment transaction using the split payment definition, deducting, by the PPU, the portion to be charged associated with each of the one or more participants from an account associated with each of the one or more participants;
wherein upon receiving the split payment definition by the PPU,
storing the split payment definition and an identity of the user device;
sending a notification to each of the one or more participants indicating the split payment definition;
assigning to each of the one or more participants a status as waiting;
wherein when a participant receives a deny notification, removing the participant from the split payment definition and updating the status of the participant to denying participant and notifying the user about the deny notification and identity of the denying participant; when a participant receives an approve notification, updating the status of the participant to approving participant and notifying the user device about the approve notification and identity of the approving participant; and updating the split payment definition based on the status of each of the one or more participants;
wherein upon the determination that the payment password or payment PIN for the payment transaction matches the unique password or unique PIN assigned to the split payment definition, transferring, by the PPU, to a user's account, a portion to be charged from each of the approving participants;
calculating, by the PPU, a first amount, the first amount being equal to a total portion successfully transferred from the approving participants;
calculating, by the PPU, a second amount, the second amount being equal to a user's available balance in the user's account;
upon a determination, by the PPU, that a sum of the first amount and the second amount is equal to or greater than a payment transaction amount, confirming the payment transaction, and
upon a determination, by the PPU, that a sum of the first amount and the second amount is less than the payment transaction amount, transferring the amount charged back to each of the approving participants.

28. The method of claim 27, when the determination that the unique password or PIN is not defined for the split payment, the purchase transaction is processed with the payment instrument as a standard purchase transaction over an account balance to which the payment instrument is linked.
